(19) United States
(12) Patent Application Publication
(10) Pub. No.: US 2004/0129916 A1
(43) Pub. Date: Jul. 8, 2004

(54) Gel-type composition, gel-type ionic conducting compositions containing the same as the base and batteries and electrochemical elements made by using the compositions

(76) Inventors: Kazuchiyo Takaoka, Tokyo (JP); Mutsuhiro Matsuyama, Tokyo (JP); Kenji Hyodo, Tokyo (JP); Wakana Aizawa, Tokyo (JP); Takakazu Hino, Kanagawa (JP); Naoki Suzuki, Tokyo (JP)

Correspondence Address: BIRCH STEWART KOLASCH & BIRCH, PO BOX 747, FALLS CHURCH, VA, 22040-0747, US

(21) Appl. No.: 10/031,749

(22) PCT Filed: May 23, 2001
(86) PCT No.: PCT/JP01/04314

(30) Foreign Application Priority Data
May 24, 2000 (JP) 2000-153694
Dec. 6, 2000 (JP) 2000-371594

(51) Int. Cl. C08J 3/00; C08J 5/20

(52) U.S. Cl. 252/62.2; 524/543; 429/303

(57) ABSTRACT

The present invention provides a gelled composition comprising a polymer and a solvent, said polymer being obtained by an addition reaction between a linear copolymer having two terminal hydrosilyl groups and a compound having 3 or more ethylenic double bonds, wherein

said linear copolymer being formed by copolymerizing a compound represented by the formula (A):

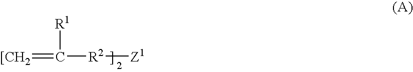

and a compound represented by the formula (B):

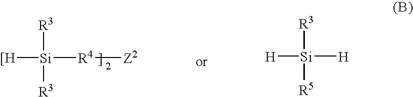

said compound having 3 or more ethylenic double bonds being a compound represented by the formula (D):

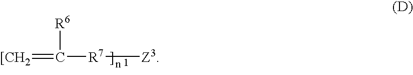

### TECHNICAL FIELD

This invention relates to a gelled composition, a gelled ionic conductive composition based on the gelled composition, and a battery and an electrochemical device using the gelled ionic conductive composition. More specifically, the present invention relates to a gelled composition containing a block polymer, a gelled ionic conductive composition based on the gelled composition, and a battery and a capacitor using the gelled ionic conductive composition.

### BACKGROUND ART

Ionic conductive materials are used in various batteries and electrochemical devices, such as primary batteries, secondary batteries, solar cells, capacitors, sensors, and electrochromic display devices. In the recent electronic industrial field, higher performance of various electronic components has been sought for, and their downsizing and thin film formation have increasingly proceeded. Thus, improvements along this line are desired also for ionic conductive materials used for batteries and electrochemical devices. Moreover, ionic conductive materials used in the form of liquids or fluids have posed problems, such as damage to surroundings due to liquid leakage.

To cope with these problems, solid electrolyte materials, such as polymer electrolytes and gel electrolytes, have recently been proposed. These materials have excellent characteristics, such as relatively high ionic conductivity, wide potential window, satisfactory thin film-forming properties, flexibility, lightweight, elasticity, and transparency. Of these characteristics, properties characteristic of polymer electrolytes, such as flexibility and elasticity, are particularly important to lithium secondary batteries, in which many electrode active materials change in volume during operation, because these properties can accommodate such volume changes. It is also said that polymer electrolytes and gel electrolytes have the ability to prevent decreases in battery capacity during repeated use, and short-circuiting of positive and negative electrode materials, which are ascribed to detachment of electrode materials.

Japanese Patent Publication No. 23944/86 touches on polyamide resins of a one-dimensional structure as organic polymeric compounds for use in such polymer electrolytes, but concretely discloses no polyamide resins.

Advanced Materials, 10, 439 (1998) introduces polyoxyethylenes; complexes of polyoxyethylenes and polysiloxanes; complexes of polyoxyethylenes and polyphosphagens; and polymers of a crosslinked structure having polyoxyethylene as a structural unit, and also having epoxy groups, isocyanate groups, and further a siloxane structure. Especially, the polymers of a crosslinked structure having polyoxyalkylene groups and a polysiloxane structure are excellent in low-temperature characteristics, and are thus polymer electrolytes worthy of attention.

As such polymers having polyoxyalkylene groups and polysiloxane structural units for use in polymer electrolytes, J. Polym. Sci. Polym. Lett. Ed., 22, 659 (1984) discloses

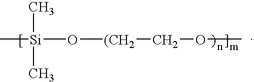

Solid State Ionics, 15, 233 (1985) discloses

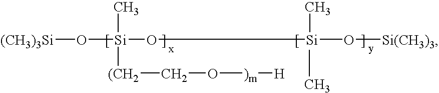

Japanese Unexamined Patent Publication No. 136409/88 discloses

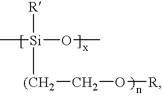

Japanese Unexamined Patent Publication No. 1996-78053 discloses silicone compounds of the formula:

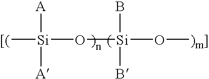

where A and A′ are alkyl groups, and B and/or B′ denote(s) an oxyalkylene chain. All of these polymers merely have a polyoxyalkylene chain as a side chain bound to a polysiloxane main chain.

Japanese Examined Patent Publication No. 1996-21389 discloses a polysiloxane crosslinked cured product having organic groups having oxyalkylene groups or polyoxyalkylene groups as side chains and/or crosslinking portions. Japanese Examined Patent Publication No. 1994-35545 discloses a polysiloxane crosslinked cured product of the following formula:

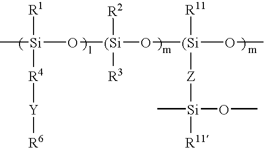

where R¹, R², R³, R¹¹ and R^{11′} are each an alkyl group, an alkoxy group or an aryl group, R⁴ is an alkylene group, an oxyalkylene group or an oxycarbonylalkylene group, R⁵ is a hydrogen atom or an alkyl group, Y is an oxyalkylene group or a polyoxyalkylene group, and Z is a group having an oxyalkylene group, a polyoxyalkylene group or a polysiloxane structure at each end thereof.

However, these cured products all pose the problems that the stability of the polymers themselves is problematical, that they do not give crosslinked structures suppressing detachment of electrode materials and permitting thin layer formation, and that sufficient ionic conductivity is not obtained. Thus, they have not been put to practical use.

As an ionic conductive composition capable of solving these problems, International Application PCT/JP99/05707 describes a gelled ionic conductive composition obtained by gelling a polymer which is formed by crosslinking a linear alternating copolymer by use of a hydrosilylation reaction, the linear alternating copolymer being obtained by the hydrosilylation reaction of a compound having two hydrosilyl groups of the following formula:

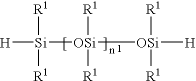

with a compound having two ethylenic double bonds.

However, such an ionic conductive composition based on a polymer having a polysiloxane skeleton has been shown to have the drawback of deteriorating because the polysiloxane skeleton is decomposed by an acid formed by the reaction between existent electrolytes and unremovable trace water, or by a decomposition product of electrolytes themselves formed by heating.

The object of the present invention is to provide a stable gelled composition, a gelled ionic conductive composition based on the gelled composition, and a battery and an electrochemical device using the gelled ionic conductive composition.

### DISCLOSURE OF THE INVENTION

According to a first aspect, the present invention provides a gelled composition containing a polymer and a solvent, the polymer being obtained by an addition reaction between a linear copolymer having two terminal hydrosilyl groups and a compound having 3 or more ethylenic double bonds, wherein

said linear copolymer being formed by copolymerizing a compound represented by the formula (A) [hereinafter referred to as Compound (A)]:

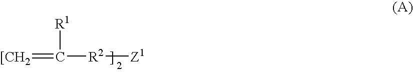

where R¹ represents, independently of each other, a hydrogen atom, a substituted or unsubstituted alkyl group having 1 to 18 carbon atoms, or a substituted or unsubstituted aryl group having 6 to 20 carbon atoms, R² represents, independently of each other, a substituted or unsubstituted alkylene group having 1 to 18 carbon atoms, a substituted or unsubstituted arylene group having 6 to 20 carbon atoms, a substituted or unsubstituted arylalkylene group having 7 to 21 carbon atoms, a dialkyl(poly)silylene group, a diaryl(poly)silylene group, or a bond, and Z¹ represents a polyoxyalkylene group, a (poly)carbonate group, a (poly)ester group, an alkylene group having 1 to 36 carbon atoms, a hetero-atom-containing organic group having 1 to 6 hetero-atoms and 1 to 30 carbon atoms, a divalent group derived from polyacrylate or polymethacrylate, or a bond,

and a compound represented by the formula (B) [hereinafter referred to as Compound (B)]:

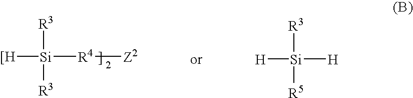

where R³ represents, independently of each other, a substituted or unsubstituted alkyl group having 1 to 18 carbon atoms, a substituted or unsubstituted aralkyl group having 7 to 21 carbon atoms, a substituted or unsubstituted alkylene group having 1 to 18 carbon atoms, a substituted or unsubstituted arylene group having 6 to 20 carbon atoms, a substituted or unsubstituted arylalkylene group having 7 to 21 carbon atoms, a dialkyl(poly)silylene group, a diaryl(poly)silylene group, or a bond, R⁵ represents a substituted or unsubstituted alkyl group having 2 to 18 carbon atoms, a substituted or unsubstituted aralkyl group having 7 to 21 carbon atoms, or a substituted or unsubstituted aryl group having 6 to 20 carbon atoms, and Z² represents a divalent linking group which is a disubstituted divalent silicon atom, a substituted or unsubstituted alkylene group having 1 to 18 carbon atoms, a substituted or unsubstituted arylene group having 6 to 20 carbon atoms, a hetero-atom-containing organic group having 1 to 6 hetero-atoms and 1 to 30 carbon atoms, a benzenepolycarboxyl group, a phosphate group, a polyoxyalkylene group, a (poly)carbonate group, a (poly)ester group, a group derived from polyacrylate or polymethacrylate, or a bond, and said linear copolymer being represented by the formula (C) [hereinafter referred to as Linear Copolymer (C)]:

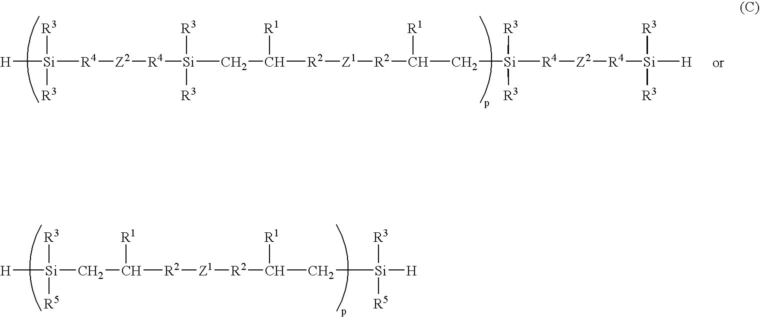

where R¹, R², R³, R⁴, R⁵, Z¹ and Z² are as defined above and p denotes an integer of 1 to 100;

said compound having 3 or more ethylenic double bonds being a compound represented by the formula (D) [hereinafter referred to as Compound (D)]:

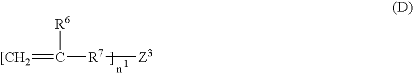

where R⁶ represents, independently of each other, a hydrogen atom, a substituted or unsubstituted alkyl group having 1 to 18 carbon atoms, or a substituted or unsubstituted aryl group having 6 to 20 carbon atoms, R⁷ represents, independently of each other, a substituted or unsubstituted alkylene group having 1 to 18 carbon atoms, a substituted or unsubstituted arylene group having 6 to 20 carbon atoms, a substituted or unsubstituted arylalkylene group having 7 to 21 carbon atoms, a hetero-atom-containing alkylene group having 1 to 6 hetero-atoms and 1 to 30 carbon atoms, or a bond, n¹ denotes an integer of 3 or higher, and Z³ represents a linking group having the same valence number as n¹ which is a carbon atom, an alkynyl group having 1 to 18 carbon atoms, an alkanepolyyl group having 1 to 12 carbon atoms, a silicon atom, a monosubstituted trivalent silicon atom, an aliphatic group having 1 to 300 carbon atoms, a hetero-atom-containing organic group having 1 to 50 hetero-atoms and 1 to 100 carbon atoms, a benzenepolycarboxyl group, a phosphate group, an oxyphosphate group, a group derived from (poly)carbonate, poly(ester), polyacrylate or polymethacrylate, or a bond; and

said addition reaction being carried out in the presence or absence of Compound (A) and/or (B).

According to another embodiment of this aspect, the present invention provides a gelled composition containing a polymer and a solvent, the polymer being obtained by the simultaneous addition reaction of Compound (A), Compound (B) and Compound (D).

According to still another embodiment of this aspect, the present invention provides a gelled composition containing a polymer and a solvent, the polymer being obtained by an addition reaction of Compound (B) and Compound (D).

According to a second aspect, the present invention provides a gelled composition containing a polymer and a solvent, the polymer being obtained by the addition reaction of a compound having two terminal ethylenic double bonds which is derived from a linear copolymer formed by copolymerizing Compound (A) and Compound (B) and represented by the formula (E) [hereinafter referred to as Linear Copolymer (E)]:

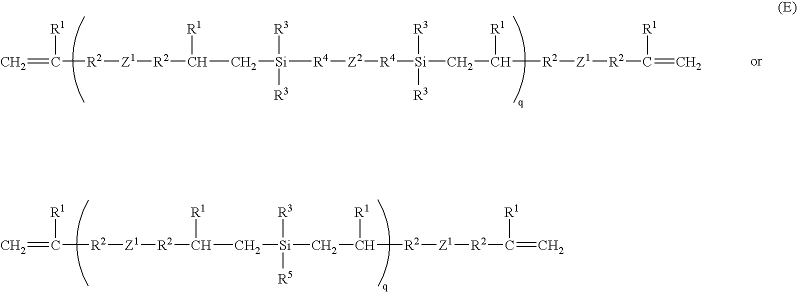

where R¹, R², R³, R⁴, R⁵, Z¹ and Z² are as defined above and q denotes an integer of 1 to 100, with a compound having 3 or more hydrosilyl groups represented by the formula (F) [hereinafter referred to as Compound (F)]:

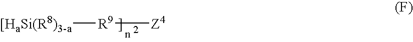

where R⁸ represents, independently of each other, a substituted or unsubstituted alkyl group having 1 to 18 carbon atoms, or a substituted or unsubstituted aryl group having 6 to 20 carbon atoms, R⁹ represents, independently of each other, a substituted or unsubstituted alkylene group having 1 to 18 carbon atoms, a substituted or unsubstituted arylene group having 6 to 20 carbon atoms, a substituted or unsubstituted arylalkylene group having 7 to 21 carbon atoms, a hetero-atom-containing alkylene group having 1 to 6 hetero-atoms and 1 to 30 carbon atoms, or a bond, Z⁴ represents a linking group having the same valence number as n² which is a carbon atom, an alkynyl group having 1 to 18 carbon atoms, an alkanepolyyl group having 1 to 12 carbon atoms, a silicon atom, a monosubstituted trivalent silicon atom, an aliphatic group having 1 to 300 carbon atoms, a hetero-atom-containing organic group having 1 to 50 hetero-atoms and 1 to 100 carbon atoms, a benzenepolycarboxyl group, a phosphate group, an oxyphosphate group, a group derived from (poly)carbonate, poly(ester), polyacrylate or polymethacrylate, or a bond, a represents, independently of each other, an integer of 1 to 3, and n² denotes an integer of 1 to 30, provided that when n² is 1, R⁹ represents a bond, and Z⁴ represents a hydrogen atom or has the same meaning as R⁸, and that in any case, at least 3 hydrogen atoms bonded to one or more Si atoms are present in the molecule, in the presence or absence of Compound (A) and/or Compound (B).

According to another embodiment of this aspect, the present invention provides a gelled composition containing a polymer and a solvent, the polymer being obtained by the simultaneous addition reaction of Compound (A), Compound (B) and Compound (F).

According to still another embodiment of this aspect, the present invention provides a gelled composition containing a polymer and a solvent, the polymer being obtained by an addition reaction of Compound (B) and Compound (F).

According to a third aspect, the present invention provides a gelled ionic conductive composition based on the gelled composition.

According to a fourth aspect, the present invention provides a battery and an electrochemical device containing the gelled ionic conductive composition.

According to a fifth aspect, the present invention provides a method for producing a battery and an electrochemical device containing the gelled ionic conductive composition.

### PREFERRED EMBODIMENTS FOR CARRYING OUT THE INVENTION

In the first aspect of the present invention, the alkyl group having 1 to 18 carbon atoms, described as R¹ in the formula (A), includes, for example, a methyl group, an ethyl group, a propyl group, a butyl group, an octyl group, and a dodecyl group, and the aryl group having 6 to 20 carbon atoms includes, for example, a phenyl group, a toluyl group, and a naphthyl group. Preferably, R¹ is a hydrogen atom, or an alkyl group preferably having 1 to 6 carbon atoms, more preferably having 1 to 3 carbon atoms, and most preferably, is a hydrogen atom or a methyl group.

The alkylene group having 1 to 18 carbon atoms, described as R² in the formula (A), includes, for example, a methylene group, an ethylene group, a propylene group, a butylene group, an octylene group, and a dodecylene group, and the arylene group having 6 to 20 carbon atoms includes, for example, a phenylene group, a toluylene group, and a naphthylene group. The arylalkylene group having 7 to 21 carbon atoms includes, for example, a phenylmethylene group, a phenylethylene group, and a phenylethylidene group. The alkyl group of the dialkyl(poly)silylene group, described as R², preferably has 1 to 6 carbon atoms, and includes, for example, a methyl group, an ethyl group, a propyl group, and a butyl group. The aryl group of the diaryl(poly)silylene group preferably has 6 to 10 carbon atoms, and includes, for example, a phenyl group, a toluyl group, and a naphthyl group. Preferably, R² is an alkylene group having 1 to 6 carbon atoms, more preferably having 1 to 3 carbon atoms, and most preferably, is a methylene group or a bond.

The polyoxyalkylene group, described as Z¹ in the formula (A), is preferably a divalent group having oxygen atoms at both ends, which is derived from a polymer of an alkylene oxide having 1 to 6 carbon atoms, and includes, for example, poly(oxymethylene), poly(oxyethylene), poly(oxypropylene), poly(oxybutylene), poly(oxypentylene), and copolymers of them. The (poly)carbonate group is a divalent group having oxygen atoms at both ends, which has a glycol, such as ethylene glycol or propylene glycol, or a polyglycol, or an arylenediol, such as phenylenediol, or a polyarylenediol, connected via —O(CO)O—, the glycol having preferably 1 to 12, more preferably 2 to 8, most preferably 2 to 6 carbon atoms, and the arylenediol having preferably 6 to 10, more preferably 6 to 8, most preferably 6 carbon atoms. The poly(ester) group is a divalent group having oxygen atoms at both ends, which is obtained by dehydration condensation of a dicarboxylic acid, such as glycolic acid, adipic acid, phthalic acid or terephthalic acid, with a glycol, such as ethylene glycol or propylene glycol, or a polyglycol, or an arylenediol, such as phenylenediol, or a polyarylenediol. The glycol and the arylenediol in this case may be the same as those in the case of the poly(carbonate) group. The hetero-atom-containing organic group having 1 to 6 hetero-atoms and 1 to 30 carbon atoms is a group containing an oxygen, sulfur or nitrogen atom as a hetero-atom, and any of these hetero-atoms may be present between carbon atoms to form an ether, a thioether and/or a secondary amino group, or may be present on a carbon atom to form a carbonyl, a thiocarbonyl and/or an imino group, or a mixture of these. Thus, the hetero-atom-containing organic group includes an amide group as well. Also, the hetero-atom-containing organic group may have a substituent group such as a halogen or a cyano group. The polyoxyalkylene group, the (poly)carbonate group, the (poly)ester group, the hetero-atom-containing organic group having 1 to 6 hetero-atoms and 1 to 30 carbon atoms, and the divalent group derived from polyacrylate and polymethacrylate each have a molecular weight of 60 to 30,000, preferably 100 to 10,000, more preferably 200 to 5,000, most preferably 300 to 4,000. Preferably, Z¹ is a polyoxyalkylene group having a molecular weight of 300 to 4,000, and is a poly(oxyethylene) group, a poly(oxypropylene) group, or a copolymer of them.

If R¹, R² and Z¹ in the formula (A) have substituents, these substituents include halogens such as chlorine, fluorine, and bromine, and a cyano group. Examples of the groups having substituents include alkyl halide groups, such as a trifluoropropyl group and a chloropropyl group, and cyanoalkyl groups, such as a 2-cyanoethyl group.

Concrete examples of Compound (A) are polyoxyalkylenes having ethylenic double bonds at both ends, such as

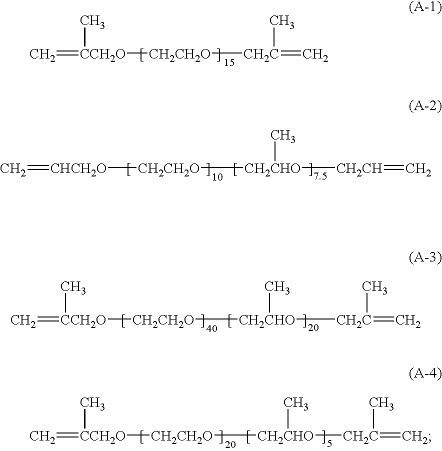

polycarbonates having ethylenic double bonds at both ends, such as

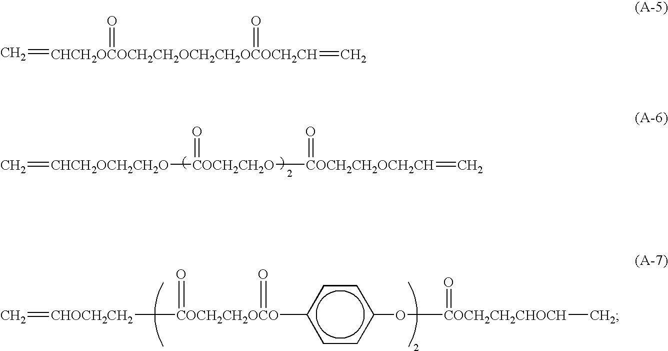

polyesters having ethylenic double bonds at both ends, such as

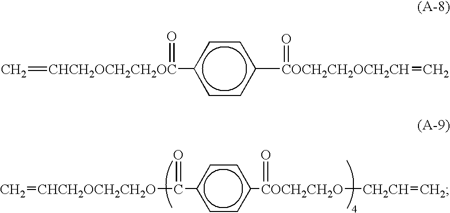

alkylenes having ethylenic double bonds at both ends, such as

CH₂═CHCH₂CH₂CH₂CH₂CH₂CH═CH₂ (A-10)

compounds having ethylenic double bonds at both ends, such as

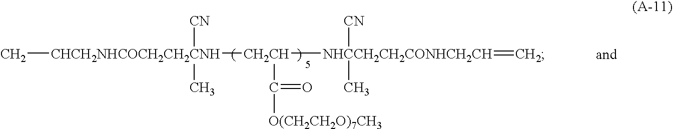

compounds having ethylenic double bonds at both ends, such as

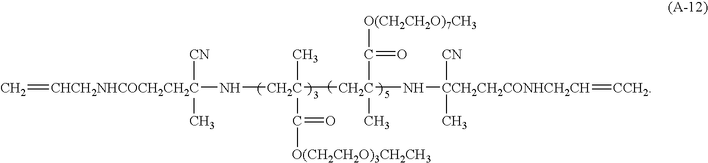

Next, the alkyl group having 1 to 18 carbon atoms and the aryl group having 6 to 20 carbon atoms, each described as R³ in the formula (B), are the same as those shown in connection with R¹ in the formula (A). The aralkyl group having 7 to 21 carbon atoms, described as R³, includes, for example, a benzyl group and a phenethyl group. Preferably, R³ is an alkyl group having 1 to 6, more preferably 1 to 3 carbon atoms, and is most preferably a methyl group.

Examples of the alkylene group having 1 to 18 carbon atoms, the arylene group having 6 to 20 carbon atoms, the arylalkylene group having 7 to 21 carbon atoms, the dialkyl(poly)silylene group, and the diaryl(poly)silylene group, each described as R⁴ in the formula (B), are the same as those shown in connection with R² in the formula (A). Preferably, R⁵ is an alkylene group having 1 to 6, more preferably 1 to 3 carbon atoms, and is most preferably a methylene group or a bond.

R⁵ in the formula (B) has the same meaning as R³, except that the carbon number of the alkyl group represented thereby is 2 to 18.

The substituents of the disubstituted divalent silicon atom, described as Z² in the formula (B), include alkyl groups having 1 to 18 carbon atoms or aryl groups having 6 to 20 carbon atoms, preferably alkyl groups having 1 to 6, more preferably, 1 to 3 carbon atoms, and most preferably, a methyl group. Thus, the preferred disubstituted divalent silicon atom is a dialkylsilyl group, and most preferably, a dimethylsilyl group. Examples of the alkylene group having 1 to 18 carbon atoms and the arylene group having 6 to 20 carbon atoms, each described as Z², are the same as those shown in connection with R² in the formula (A). Examples of the hetero-atom-containing organic group having 1 to 6 hetero-atoms and 1 to 30 carbon atoms, the polyoxyalkylene group, the (poly)carbonate group, and the (poly)ester group, each described as Z², are the same as those shown in connection with Z¹ in the formula (A). The molecular weight of the divalent group including polyacrylate and polymethacrylate in addition to the above groups is the same as that shown in connection with Z¹ in the formula (A). Preferably, Z² is a dimethylsilyl group, an alkylene group having 1 to 12 carbon atoms, a phenylene group, a polyoxyalkylene group having a molecular weight of 100 to 10,000, such as a poly(oxyethylene) group, a poly(oxypropylene) group, or a copolymer thereof, a (poly)carbonate group, or a (poly)ester group.

If R³, R⁴, R⁵ and Z² in the formula (B) have substituents, examples of these substituents are the same as those shown in connection with R¹, R² and Z¹ in the formula (A).

Concrete examples of Compound (B) are compounds such as

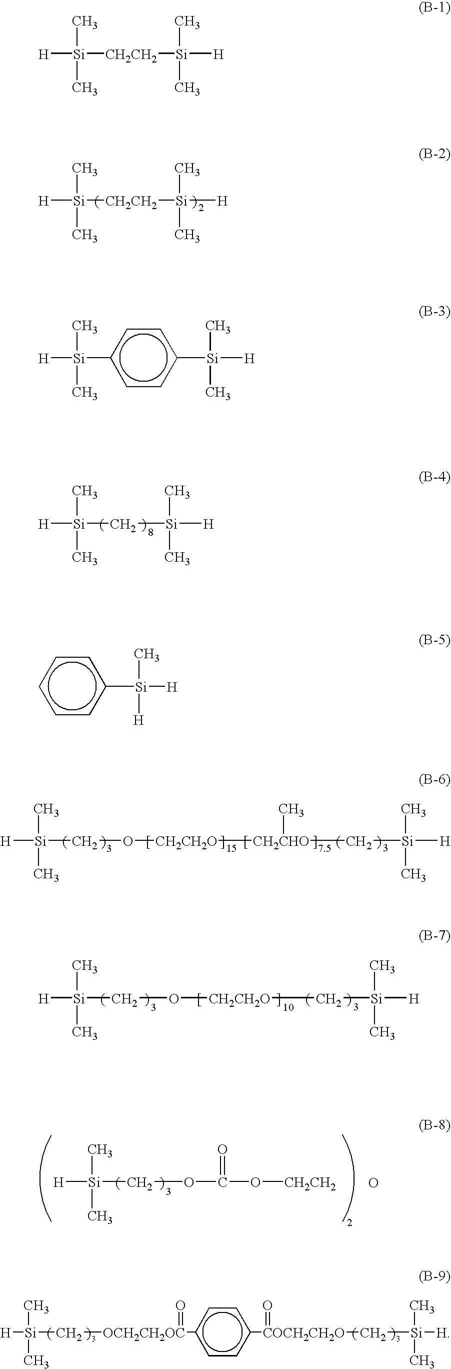

Examples of the alkyl group having 1 to 18 carbon atoms and the aryl group having 6 to 20 carbon atoms, each described as R⁶ in the formula (D), are the same as those shown in connection with R¹ in the formula (A).

Examples of the alkylene group having 1 to 18 carbon atoms, the arylene group having 6 to 20 carbon atoms, and the arylalkylene group having 7 to 21 carbon atoms, each described as R⁷ in the formula (D), are the same as those shown in connection with R² in the formula (A). Examples of the hetero-atom-containing alkylene group having 1 to 6 hetero-atoms and 1 to 30 carbon atoms, described as R⁷, include an alkyl-polyoxyalkylene-alkyl group, as well as the examples shown in connection with Z¹ in the formula (A). This alkyl group includes an alkyl group having 1 to 6 carbon atoms, such as a methyl group, an ethyl group, a propyl group, or a butyl group. Thus, examples of the alkyl-polyoxyalkylene-alkyl group include, concretely, methyl-poly(oxyethylene)-methyl, methyl-poly(oxypropylene)-methyl, methyl-poly(oxyethylene)-propyl, ethyl-poly(oxybutylene)-ethyl, ethyl-poly(oxypentylene)-propyl, and copolymers of these.

The alkynyl group having 1 to 18 carbon atoms, described as Z³ in the formula (D), includes a methyl group, an ethynyl group, a propynyl group, a butynyl group, an octyl group, and a dodecynyl group. An alkynyl group having 1 to 12 carbon atoms is preferred, and an alkynyl group having 1 to 6 carbon atoms is more preferred. The alkanepolyoxy group having 1 to 12 carbon atoms, described as Z³, includes 1,2,3-propanetrioxy group, 1,2,3,4-butanetetraoxy group, and 1,2,3,4,5,6-hexanehexaoxy group. The monosubstituted trivalent silicon atom, described as Z³, includes, for example, the formula ≡Si-alkyl, the alkyl being an alkyl group having 1 to 6, more preferably 1 to 3 carbon atoms, and most preferably, a methyl group. Therefore, ≡Si—CH₃ can be named as the most preferable example of the ≡Si-alkyl. The wording “hetero-atom-containing organic group” used in connection with Z³, which is one having 1 to 50 hetero-atoms and 1 to 100 carbon atoms, described as Z³, refers to an aliphatic or aromatic group containing oxygen, sulfur or nitrogen atoms as hetero-atoms. Any of these hetero-atoms may be present between carbon atoms to form an ether, a thioether and/or a secondary amino group, or may be present on a carbon atom to form a carbonyl, a thiocarbonyl and/or an imino group, or a mixture of these. Thus, the hetero-atom-containing organic group includes an amide group as well. Such a group includes a group formed by bonding of an alkylene group having 1 to 6 carbon atoms, an arylene group having 6 to 10 carbon atoms, or an arylenedialkylene group having 8 to 22 carbon atoms to an alkynyl group having 1 to 6 carbon atoms via an ether linkage, such as a methyleneoxymethynyl group, a methyleneoxyethynyl group, a methyleneoxypropynyl group, an ethyleneoxypropynyl group, a methyleneoxyethyleneoxymethynyl group, an emethyleneoxyethyleneoxyethynyl group, a propyleneoxyethyleneoxypropynyl group, or a phenylenebis(methyloxyethynyl) group; a trioxotriazine group; and these groups some of whose oxygen atoms are substituted by sulfur and/or nitrogen atoms. The benzenepolycarboxyl group, described as Z³, includes, groups derived from a benzenetricarboxylic acid and a benzenetetracarboxylic acid. Examples of the polyoxyalkylene, the (poly)carbonate and the (poly)ester, described as Z³, are the same as those shown in connection with Z¹ in the formula (A). The molecular weight of any of these polymers cited in addition to polyacrylate and polymethacrylate is the same as that shown in connection with Z¹ in the formula (A).

Preferably, R⁶ is a hydrogen atom or methyl, and R⁷ is —CH₂OCH₂—, —CH₂OCH₂CH₂—, or —CH₂OCH₂CH₂OCH₂—.

Concrete examples of Compound (D) are as follows:

(CH₂═CHCH₂—O—CH₂—)₃C—CH₂—O—CH₃ (D-1)

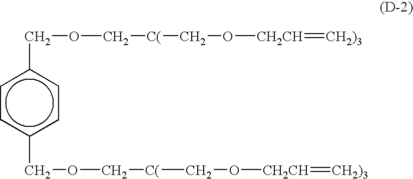 (CH₂═CHCH₂—O—CH₂—)₄C (D-3)

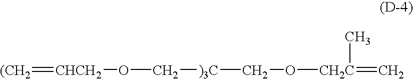 (CH₂═CHCH₂—O—CH₂CH₂—O—CH₂)₃C—CH₂CH₃ (D-5)

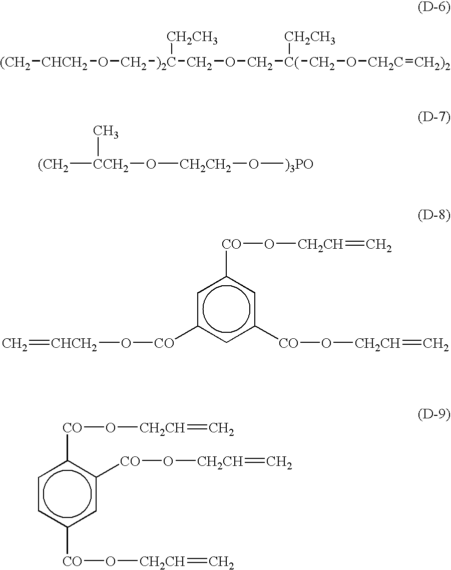 (CH₂═CHCH₂—O—CH₂—)₃C—CH₂—OH (D-10)

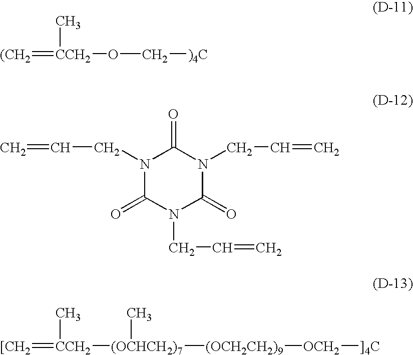 [CH₂═CH—CH₂—(OCH₂CH₂CH₂)₆—(OCH₂CH₂)₈—OCH₂—]₄C (D-14)

[CH₂═CH—CH₂—(OCH₂CH₂)₅—OCH₂—]₄C (D-15)

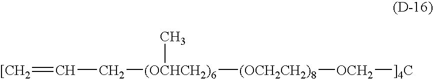 [CH₂═CH—CH₂—(OCH₂CH₂CH₂)₂—(OCH₂CH₂)₅—OCH₂—]₃C—CH₂OCH₃ (D-17)

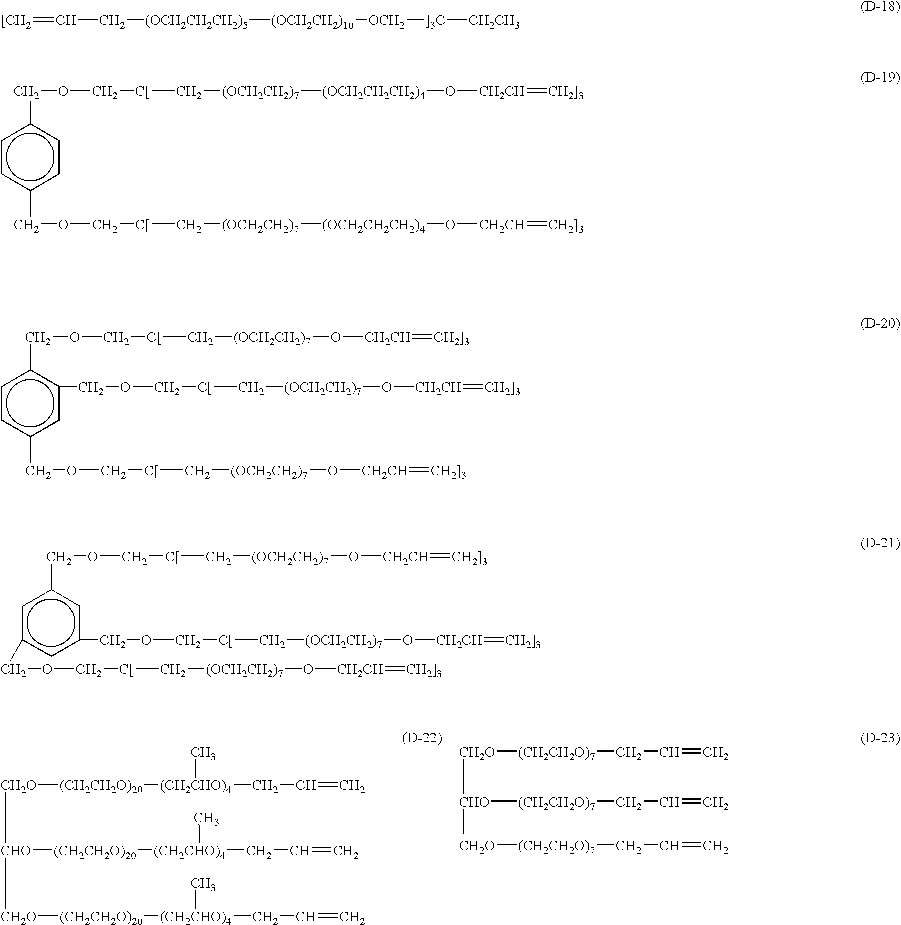

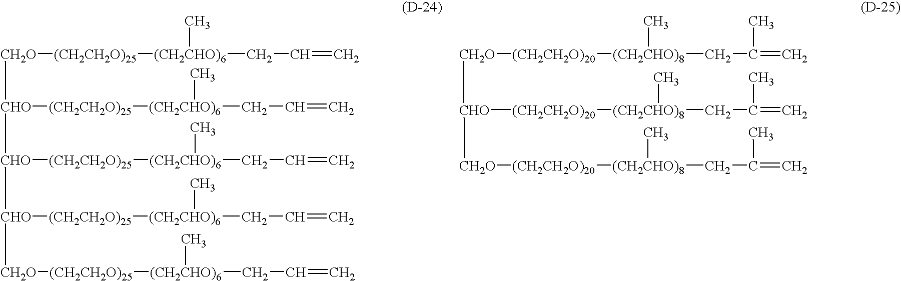

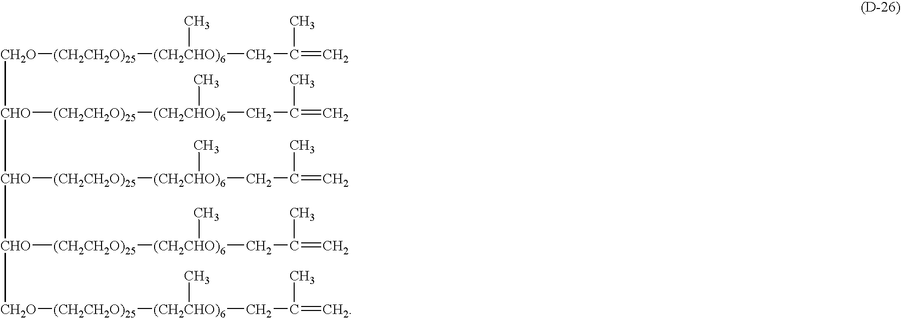

Examples of the groups represented by R⁸, R⁹ and Z⁴ in the formula (F) are the same as those shown in connection with R⁶, R⁷ and Z³ in the formula (D), except that the valence number of Z⁴ can be 1 or 2, and that Z⁴ can be a hydrogen atom or can have the same meaning as R⁸. The preferred examples of R⁸, R⁹ and Z⁴ are also the same as those shown in connection with R⁶, R⁷ and Z³ in the formula (D).

When n² is 1, R⁹ represents a bond, and Z⁴ represents a hydrogen atom or has the same meaning as R⁸, as described above. Consequently, Compound (F) includes compounds comprising a single Si atom and at least 3 hydrogen atoms.

Concrete examples of Compound (F) are as follows:

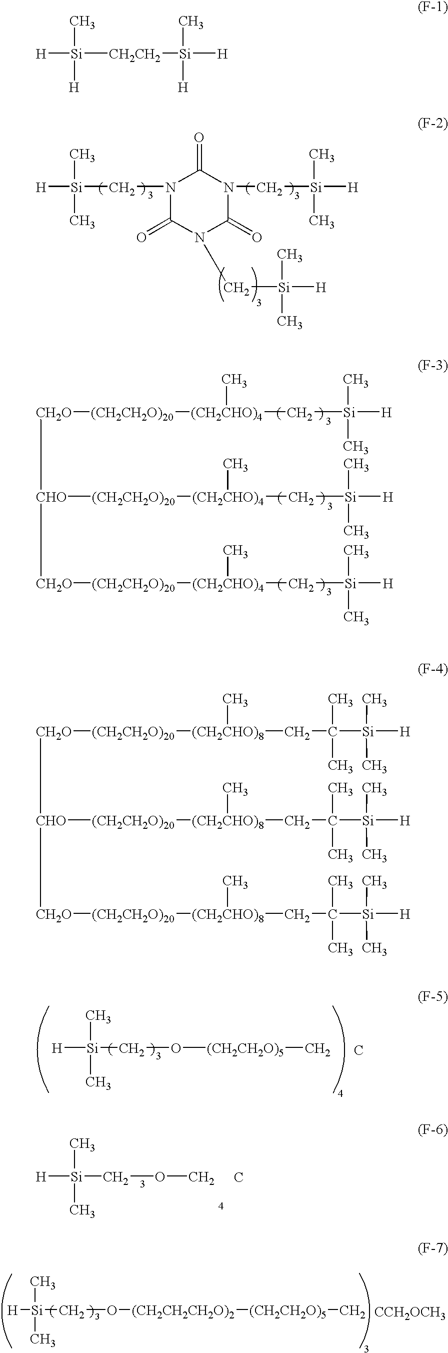

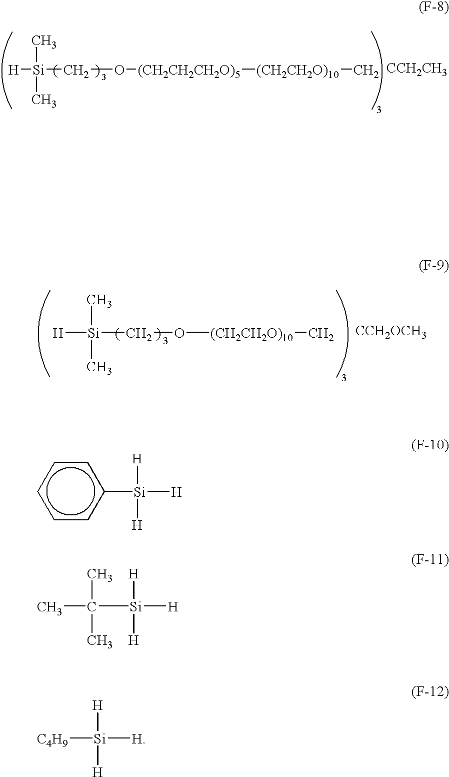

According to the first aspect of the present invention, Compound (A) alternately reacts with an excess of Compound (B) to form Linear Copolymer (C) having two terminal hydrosilyl groups. For example, when 1 mol of Compound (A) is reacted with 2 moles of Compound (B), 1 mol of Linear Copolymer (C) having the average structure BAB is formed. When 2 moles of Compound (A) is reacted with 3 moles of Compound (B), 1 mol of Linear Copolymer (C) having the average structure BABAB is formed. When 3 moles of Compound (A) is reacted with 4 moles of Compound (B), 1 mol of Linear Copolymer (C) having the average structure BABABAB is formed.

The addition reaction (hydrosilylation reaction) between Compound (A) and Compound (B) can be promoted by mixing these compounds at a temperature not higher than room temperature, followed by heating, because the reaction rate is greatly temperature-dependent. This is the major advantage of the hydrosilylation reaction. By mixing the reactants to form a mixture having a suitable viscosity, shaping the mixture, and then heating the shaped mixture, a polymer of the desired shape can be obtained at a stretch. The heating temperature is from about 50° C. to 150°, preferably from about 60° C. to 120° C. A catalyst is used for this hydrosilylation. Platinum, ruthenium, rhodium, palladium, osmium, iridium compounds and the like are known as the catalyst. For use in a battery, platinum compounds are particularly useful, because of requirements such that the catalyst should have high activity permitting the reaction to proceed promptly, should not cause a secondary reaction with the reaction product, and should not affect battery characteristics. Examples of the platinum compounds are chloroplatinic acid, metallic platinum, solid platinum carried on a carrier such as alumina, silica or carbon black, platinum-vinylsiloxane complex, platinum-phosphine complex, platinum-phosphite complex, and a platinum alcoholate catalyst. At the time of the hydrosilylation reaction, the platinum catalyst is added in such an amount that the amount of platinum is about 0.0001% by weight to 0.1% by weight.

The molecular weight of the resulting Linear Copolymer (C) is 1,000 or higher, preferably 3,000 to 100,000.

When Linear Copolymer (C) is reacted with Compound (D), an addition reaction takes place between the hydrosilyl group of Linear Copolymer (C) and the ethylenic double bond of Compound (D) to produce the crosslinked copolymer of the present invention.

This polymer can form a network structure comprising the basic units of Linear Copolymer (C) and the crosslinking units of Compound (D), and it becomes a gelled composition when it contains a solvent.

The density of crosslinking of the crosslinked copolymer according to the first aspect of the present invention is determined to some extent by the molecular weight of Linear Copolymer (C). When Linear Copolymer (C) and Compound (D) comply with the equation (I):

0.5≦[(number of moles of D×valence number of D)]/(number of moles of C×2)]≦1.5 (I)

and particularly when the lower limit of the equation (I) is 0.8 and the upper limit is 1.2, the copolymer with the preferred density of crosslinking is obtained. It is also possible to obtain the crosslinked copolymer of the present invention, while bypassing Linear Copolymer (C), by reacting Compound (A), Compound (B) and Compound (D) at a stretch. For this purpose, when these compounds simultaneously comply with the equations (II) and (III):

0.4≦[number of moles of A/number of moles of B]≦1.2 (II)

0.05≦[(number of moles of D×valence number of D)/(number of moles of B×2)]≦1.0 (III)

and particularly when the lower limit of the equation (II) is 0.6 and the upper limit is 1.0 and the lower limit of the equation (III) is 0.1 and the upper limit is 0.6, the copolymer with the preferred density of crosslinking is obtained.

Two or more types of each of Compound (A), Compound (B) and Compound (D) may be used. In reacting Linear Copolymer (C) with Compound (D), Compound (A) and/or Compound (B) may be added.

As a solvent present in the resulting crosslinked copolymer, there can be used, for example, inorganic solvents such as water, thionyl chloride, sulfuryl chloride, and liquid ammonia; sulfur compounds such as thiophene and diethyl sulfide; nitrogen compounds such as acetonitrile, diethylamine, and aniline; fatty acids such as acetic acid and butyric acid and their acid anhydrides; ethers; acetals; ketones such as cyclohexanone; esters; phenols; alcohols; hydrocarbons; halogenated hydrocarbons; and dimethyl polysiloxane. Particularly for lithium secondary batteries, sulfur compounds, such as dimethyl sulfoxide and sulfolane; ester compounds having a carbonyl bond, such as propylene carbonate, ethylene carbonate, γ-butyrolactone, dimethyl carbonate, and diethyl carbonate; and ether compounds, such as tetrahydrofuran, 2-methoxytetrahydrofuran, 1,3-dioxolan, 1,2-dimethoxyethane, 1,2-ethoxyethane, and 1,3-dioxane, which have been purified, can be used alone or as a mixture. For an electric double layer capacitor and an electrolytic capacitor, propylene carbonate, ethylene carbonate, dimethyl carbonate, diethyl carbonate, ethyl methyl carbonate, γ-butyrolactone, dimethylformamide, dimethylacetamide, sulfolane, acetonitrile, dimethyl sulfoxide, tetrahydrofuran, and dimethoxyethane, which have been purified, can be used alone or as a mixture. Any of these solvents is present in an amount of 1 to 99% by weight, preferably 50 to 99% by weight, more preferably 80 to 97% by weight, in the gelled composition of the present invention. Of these solvents, the solvent that does not impede the hydrosilylation reaction is preferably added during production of the gelled composition. As the solvent inhibiting the hydrosilylation reaction, water and alcohol can be named.

According to another embodiment of this aspect, the present invention provides a gelled composition containing a polymer and a solvent, the polymer being obtained by an addition reaction of Compound (B) and Compound (D). In this case, it is preferred to react these compounds at such a molar ratio that the number of moles of the hydrogen atoms bonded to the Si atom in Compound (B) and the number of moles of the ethylenic double bonds in Compound (D) are equal to each other.

According to the second aspect of the present invention, an excess of Compound (A) alternately reacts with Compound (B) to form Linear Copolymer (E) having two ethylenic double bonds at both ends. For example, when 2 moles of Compound (A) is reacted with 1 mole of Compound (B), 1 mol of Linear Copolymer (E) having the average structure ABA is formed. When 3 moles of Compound (A) is reacted with 2 moles of Compound (B), 1 mol of Linear Copolymer (E) having the average structure ABABA is formed. The reaction conditions, the molecular weight of Linear Copolymer (E), etc. are the same as in the first aspect of the present invention.

When Linear Copolymer (E) is reacted with Compound (F), an addition reaction takes place between the ethylenic double bond of Linear Copolymer (E) and the hydrosilyl group of Compound (F) to produce the crosslinked copolymer of the present invention.

This polymer can form a network structure comprising the basic units of Linear Copolymer (E) and the crosslinking units of Compound (F), and it becomes a gelled composition when it contains a solvent. Examples of a solvent, which can exist in the crosslinked copolymer, are the same as those in the first aspect of the present invention.

The density of crosslinking of the crosslinked copolymer according to the second aspect of the present invention is determined to some extent by the molecular weight of Linear Copolymer (E). The equations (I) to (III) on the molar ratio between Linear Copolymer (C) and Compound (D), which have been mentioned in connection with the crosslinked copolymer according to the first aspect, apply, unchanged, to Linear Copolymer (E) and Compound (F).

Two or more types of each of Compound (A), Compound (B) and Compound (F) may be used. In reacting Compound (F) with Linear Copolymer (E), Compound (A) and/or Compound (B) may be added.

According to another embodiment of this aspect, the present invention also provides a gelled composition containing a polymer and a solvent, the polymer being obtained by an addition reaction of Compound (A) and Compound (E). In this case, it is preferred to react these compounds at such a molar ratio that the number of moles of the ethylenic double bonds in Compound (A) and the number of moles of the hydrogen atoms bonded to the Si atom in Compound (F) are equal to each other.

According to the third aspect of the present invention, there is provided a gelled ionic conductive composition formed with the use of the so obtained gelled compositions according to the first and second aspects. To maintain the dynamic characteristics and ionic conductivity of the gelled ionic conductive composition in a satisfactory state, the amount of a solvent is preferably 30 to 99% by weight, more preferably 50 to 98% by weight, most preferably 60 to 95% by weight. At this time, the storage modulus of the gel electrolyte layer is preferably 3,000 pascals or more, particularly preferably 5,000 pascals or more. The storage modulus refers to the amount showing the dynamic behavior of the gel, and needless to say, it is more preferred that its frequency characteristic does not change greatly, and the gel shows satisfactory shape stability characteristics.

The gelled ionic conductive composition of the present invention is produced by mixing electrolytes with the above polymer, and if desired, mixing or impregnating the mixture with a modified silicone, and other ingredients customarily incorporated into an ionic conductive composition. Before the polymer is obtained, all or some of these ingredients may be blended with polymerization reactants, and the remainder may be incorporated after the polymerization reaction. For example, these ingredients may be incorporated before the reaction between the linear copolymer and the crosslinking compound, or after this reaction. Alternatively, it is also permissible to incorporate some of the ingredients before the reaction, and then incorporate the remainder.

In the gelled ionic conductive composition of the present invention, the polymer of the present invention is present in an amount of 1 to 49% by weight, preferably 2 to 20% by weight.

The modified silicone refers to products formed by substituting some of the methyl groups of the dimethyl polysiloxane by a substituent, such as a polyether group, a polyester group, an alkoxy group, an alcohol group, a carboxyl group, an epoxy group-containing group, an amino group-containing group, an alkyl group, or a phenyl group. The modifying groups are incorporated into the polysiloxane chain in a pendant form, a linear form, or as a one-end modification, a both-end modification, or a both-end and side-chain modification. There may be two or more types of substituents in the modified silicone. The viscosities of such modified silicones are 10,000 cP or less, preferably 2,000 cP or less, more preferably 1,000 cP or less at 40° C. Any of these modified silicones is mixed in an amount of 0.01 to 50% by weight, preferably 0.1 to 10% by weight, in the gelled ionic conductive composition of the present invention.

As the modified silicone used, a polyether-modified silicone where polyether moieties are introduced in a pendant form is particularly preferred, which is represented by the formula (X):

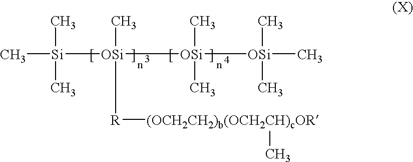

where R represents, independently of each other, an alkyl group having 2 to 4 carbon atoms (e.g., an ethyl group, a propyl group or a butyl group), R′ represents a hydrogen atom or an alkyl group having 1 to 4 carbon atoms (e.g., a methyl group, an ethyl group, a propyl group or a butyl group), n³ denotes an integer of 1 to 30, n⁴ denotes an integer of 0 to 20, b denotes an integer of 1 to 20, and c denotes an integer of 0 to 20. Concretely, the following compounds are named:

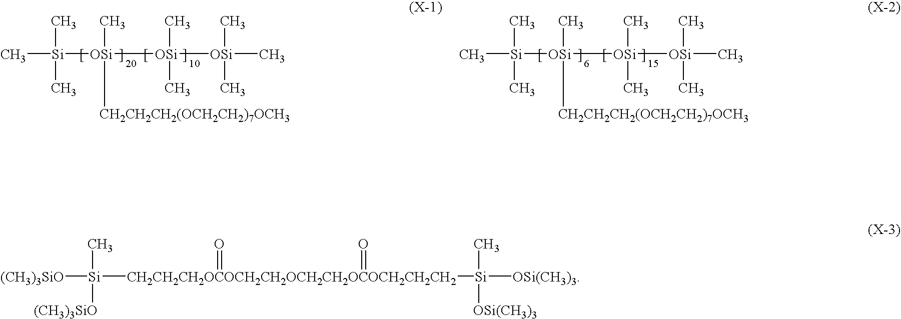

The viscosity of Compound (X-1) was measured with B Type Viscometer (produced by Tokyo Keiki, rotor No. 2, number of revolutions 60 rpm) which is a rotational viscometer, and was found to be 173 cP at 40° C.

The electrolytes for constituting the ionic conductive composition include fluorides, such as lithium fluoride, sodium fluoride, potassium fluoride and calcium fluoride, and chlorides such as sodium chloride and calcium chloride, and metal bromides, metal iodides, metal perchlorates, metal hypochlorites, metal acetates, metal formates, metal permanganates, metal phosphates, metal sulfates, metal nitrates, metal thiosulfates, metal thiocyanates, and ammonium salts such as ammonium sulfate and tetra-n-butylammonium perchlorate, and lithium salts such as LiCl, LiAlCl₄, LiClO₄, LiBF₄, LiPF₆, LiAsF₆, LiCF₃SO₃, LiN(CF₃SO₂)₂, LiC(CF₃SO₂)₃ and/or LiBPh₄ (Ph represents a phenyl group). In using the ionic conductive composition of the present invention as an electrolyte layer of an electric double layer capacitor, which is the electrochemical device of the present invention, the electrolytes include the compounds comprising cations selected from metal cations, ammonium ions, amidinium ions, and guanidium ions; and the compounds comprising anions selected from chlorine ions, bromine ions, iodine ions, perchlorate ions, thiocyanate ions, tetrafluoroborate ions, nitrate ions, AsF⁶⁻, PF⁶⁻, stearylsulfonate ions, octylsulfonate ions, dodecylbenzenesulfonate ions, naphthalenesulfonate ions, dodecylnaphthalenesulfonate ions, 7,7,8,8-tetracyano-p-quinodimethane ions, X¹SO₃⁻, [(X¹SO₂)(X²SO₂)N]⁻, [(X¹SO₂)(X²SO₂)(X³SO₂)C]⁻, and [(X¹SO₂)(X²SO₂)YC]⁻. Here, X¹, X², X³ and Y are electron attractive groups. Preferably, X¹, X², X³ are, independently of each other, a perfluoroalkyl group having 1 to 6 carbon atoms, or a perfluoroaryl group, and Y is a nitro group, a nitroso group, a carbonyl group, a carboxyl group, or a cyano group. X¹, X² and X³ may be the same or different. In using the ionic conductive composition of the present invention as an electrolyte layer of an electrolytic capacitor, the electrolytes include the compounds comprising cations selected from ammonium ions and amidinium ions; and the compounds comprising anions such as polycarboxylic acids, aliphatic polycarboxylic acids, aromatic polycarboxylic acids, alkyl- or nitro-substituted products of these polycarboxylic acids, sulfur-containing polycarboxylic acids, monocarboxylic acids, aliphatic monocarboxylic acids, aromatic monocarboxylic acids, and oxycarboxylic acids. Any of these electrolytes is present in an amount of 0.1 to 40% by weight, preferably 1 to 38% by weight, in the ionic conductive composition of the present invention.

Moreover, there can be incorporated polyalkylene oxide compounds, such as tetraethyleneglycol dimethyl ether and tetrapropyleneglycol dimethyl ether, and ionic conductive polymers, such as modified polyacrylates having polyalkylene oxides as structural units, polyacrylonitrile, polyvinylidene fluoride, and modified polyphosphazens having polyalkylene oxides as structural units.

The resulting gelled ionic conductive composition desirably is excellent in shape stability and ionic conductivity and is free from liquid leakage, and thus preferably has high storage modulus which is an indicator of gel strength. Storage modulus is a quantity showing the dynamic behavior of gel, and is determined by imposing dynamic stress with different frequencies on the gel of a constant size, and measuring the range of displacement (strain) corresponding to the width of frequency, or by measuring dynamic stress bringing about a constant range of displacement. The measurement of the displacement can be performed by RSA-II from Rheometric Company, and the measurement of dynamic stress can be made by DMA-7 from Perkin-Elmer. The greater the storage modulus, the harder the gel is judged. For example, the storage modulus is of the order of 10⁻² for water, 10¹⁰ for polystyrene, and 10¹² for tungsten.

According to the fourth aspect of the present invention, a battery and an electrochemical device comprising the gelled ionic conductive composition are provided. In the present invention, the battery includes primary batteries and secondary batteries. The electrochemical device includes solar cells, capacitors, sensors, and electrochromic display devices. In order that they act, ionic conductivity required of them is said to be about 10⁻³ S/cm at room temperature. It is preferred that ionic conductivity, which is 50% or more of the ionic conductivity of the electrolytic solution itself, be retained. Particularly, a decrease in its ionic conductivity, if any, at a low temperature as low as −20° C. is not preferred, because the use conditions are limited.

Although the constraints of theory are not desired, the polymer of the present invention is presumed to provide a composition having satisfactory shape stability and ionic conductivity, because its orderly uniform molecular structure, compared with conventional polymers, makes it possible to disperse and hold the electrolyte or both of the electrolyte and the solvent more stably than the conventional polymers.

According to the fifth aspect, a method for producing the battery and electrochemical device comprising the gelled ionic conductive composition is provided.

The method for producing the battery using the gelled ionic conductive composition includes various methods, such as a method which comprises preparing an enclosure of a battery, placing materials into the enclosure, and then reacting the materials, with heating, in the enclosure to form the gelled ionic conductive composition; and a method comprising obtaining the gelled ionic conductive composition, and then assembling a battery. To improve the shape retention and shutdown effect of the gelled ionic conductive composition, a porous film or non-woven fabric produced from thermoplastic resin, or particles of thermoplastic resin may be used in combination. When the porous film or non-woven fabric of thermoplastic resin is used, it is impregnated with the gelled ionic conductive composition of the present invention.

The porous film produced from thermoplastic resin is that formed, for example, by monoaxially stretching a film, such as polyethylene or polypropylene, to make the film porous. A film having a weight of about 5 g/m² to 30 g/m² is used.

As the non-woven fabric sheet produced from thermoplastic resin, there can be used those which, firstly, are excellent in the properties of holding the electrolyte, and which further have low resistance to the ionic conductivity of the polymer or gel electrolyte prepared and also have excellent properties of holding the electrolyte. A wet process or a dry process can be used as a method for producing the non-woven fabric, and the weight of the non-woven fabric per unit area is 100 g/m² or less, preferably 5 to 50 g/m². The fiber material used includes, but not limited thereto, for example, polyester, polypropylene, polyethylene or Teflon,.

The particles of thermoplastic resin refer to fine particles of a material such as polyethylene, polypropylene or Teflon, and their diameters are 20 μm or less, preferably 10 μm or less. Such fine particles are synthesized by emulsion polymerization or pulverization. The mixing ratio of the particles to the gelled ionic conductive composition is preferably about 5% to 50%. Also, when the particles are present in the gelled product, the system can be deformed into a constant shape by hot pressing, and then used as the ionic conductive composition.

For the lithium primary battery, metallic lithium can be used as a negative electrode, and graphite fluoride, γ-β type manganese dioxide, sulfur dioxide, thionyl chloride, iodine/poly(2-vinylpyridine), Ag₂CrO₄, vanadium pentoxide, CuO, or MoO₃ can be used as a positive electrode. As a substitute for the electrolytic solution of the primary battery, the gelled ionic conductive composition of the present invention is used. The battery is used in the form of a coin, a cylinder, or a sheet (paper).

For the lithium secondary battery, LiCoO₂, LiNiO₂, spinel type LiMn₂O₄, amorphous V₂O₅, a mixture of β-MnO₂ and Li₂MnO₃, Li_{4/3}Mn_{5/3}O₄ having a spinel superlattice structure, or an organic disulfide compound, such as 2,5-dimercapto-3,4-thiadiazole, is used as a positive electrode active material. To form a positive electrode material, this compound is formed into a powder, and then combining with an electrical conducting agent, such as acetylene black, and a thickening agent comprising an organic polymeric compound. The positive electrode material is coated onto aluminum which is a positive electrode current collector, so as to be used as a porous material.

The negative electrode material is prepared with the use of a negative electrode active material such as metallic lithium, lithium-aluminum alloy, Li—Pb—Cd—In alloy, lithium/graphite compound, lithium/non-graphitizing carbon compound, lithium/non-crystalline tin compound oxide, or non-crystalline cobalt-substituted lithium nitride. The negative electrode active material, if it is a metal, is plated onto a nickel plate or the like, or if otherwise, is formed into a powder as in the case of the positive electrode material, whereafter an electrical conducting agent such as acetylene black, and a thickening agent comprising an organic polymeric compound are added to the powder to form a negative electrode material. If the negative electrode material is in a pasty form as in the latter case, it is coated onto a current collector of copper or the like, so as to be used as a porous material. The gelled ionic conductive composition of the present invention is used as a substitute for the electrolytic solution of a secondary battery. The secondary battery is used in the form of a coin, a cylinder, or a sheet, like the primary battery.

The method for producing an electrochemical device using the above-described gelled ionic conductive composition is practically the same as for the battery when the electrochemical device is a capacitor. For an electric double layer capacitor, carbonaceous electrodes consisting essentially of carbon materials can be used as both of a positive electrode and a negative electrode. Activated carbon, carbon black, polyacene, etc. can be used as carbon materials. An electrical conducting material may be added, if desired, to the carbonaceous electrode in order to increase electric conductivity. An organic binder is added to the carbon material and this electrical conducting material, and the mixture is molded into a sheet form on a metallic current collector to form an electrode having the current collector integrated therewith. As the organic binder, polyvinylidene fluoride, polytetrafluoroethylene, polyimide resin, polyamide-imide resin, etc. can be used. As the metallic current collector, a foil or net of aluminum or stainless steel can be used. As the positive electrode, it is possible to use a foil comprising a valve action metal, such as aluminum, tantalum, niobium or titanium, the foil having undergone etching treatment for surface roughening and chemical conversion treatment for dielectric film formation. As the negative electrode, it is possible to use a foil of a metal, such as aluminum, tantalum, niobium or titanium.

In a preferred embodiment, the battery and electrochemical device of the present invention are produced by preparing their enclosure (cell) beforehand, then pouring the ionic conductive composition into the enclosure, and then polymerizing or crosslinking the composition to form the gelled ionic conductive composition of the present invention. Herein, the “ionic conductive composition” refers to a composition formed by incorporating a solvent and electrolytes into a compound such as Compound (A) or Compound (B), the linear copolymer, and/or the crosslinking compound, the composition being still not in the form of a gel. In a more preferred embodiment, the ionic conductive composition contains Polymer (C) having two terminal hydrosilyl groups, which is a linear copolymer obtained by an addition reaction of Compound (A) and Compound (B); Compound (D); a solvent; and electrolytes. In another preferred embodiment, the ionic conductive composition contains Polymer (E) having two terminal ethylenic double bonds, which is a linear copolymer obtained by an addition reaction of Compound (A) and Compound (B); Compound (F); a solvent; and electrolytes. In still another embodiment, the ionic conductive composition contains Compound (B), Compound (D), a solvent and electrolytes, or contains Compound (A), Compound (F), a solvent and electrolytes.

Gelation can be performed not only by heating, but by irradiation with actinic rays such as ultraviolet rays or electron rays. Gelation by heating is preferred. The heating temperature is 30 to 150° C., preferably 40 to 90° C. If gelation proceeds too rapidly, the initial viscosity of the ionic conductive composition becomes so high that the resulting gelled ionic conductive composition may fail to extend uniformly into the battery or the electrochemical device. Generally, if the viscosity of the ionic conductive composition immediately after preparation is 30 mPa·s or less at 25° C. and the increase of viscosity up to 6 hours thereafter is within 300%, the gelled ionic conductive composition can be formed evenly in the cell. The increase of viscosity is determined by the following equation (1):

Viscosity increasing rate (%)=(V₆−V₀)/V₀×100

where V₀ is a viscosity immediately after the preparation of gelled ionic conductive composition and V₆ is a viscosity 6 hours after the preparation.

To set the increase of viscosity at 25° C. within the above range, it may be necessary to use a polymerization inhibitor which suppresses gelation after a solution of the ionic conductive composition is prepared. Examples of the polymerization inhibitor usable include organophosphorus compounds, benzotriazole compounds, nitrile compounds, carbon halide compounds, acetylene compounds, sulfoxide compounds, amine compounds, and maleic acid esters. Of these compounds, acetylene compounds, nitrile compounds, and maleic acid esters are preferred polymerization inhibitors, because they exert minimal adverse influence on batteries or electrochemical devices into which the ionic conductive composition has been assembled. When the polymerization inhibitor is added, its amount is 0.0001 to 1.0% by weight based on the total weight of the ionic conductive composition.

Hereinbelow, the present invention will be described in further detail with reference to Examples, but the present invention is not limited thereby.

Compounds (a-1) and (a-2) used in the Examples have the following structures:

CH₂═CH—CH₂—O—(CH₂CH₂O—)₇CH₃ (a-1)

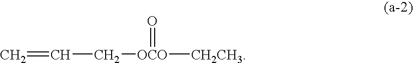

### EXAMPLES

### Example 1

The following materials were mixed:

| | |
|---|---|
| Compound (B-1) | 0.379 g |
| Compound (D-13) | 4.621 g |
| 0.25% Pt catalyst | 2.08 g |
| Ethylene carbonate | 11.91 g |
| Diethyl carbonate | 24.17 g |
| LiPF₆ | 6.8 g |

A 30 μm thick non-woven fabric was impregnated with the mixture at a weight per unit area of 15 g/m², and heated for 1 hour at 50° C. to obtain a gelled ionic conductive composition 1 with a thickness of 32 μm. The ionic conductivity of the gelled ionic conductive composition 1 was 1.5×10⁻³ S/cm.

### Example 2

The following materials were mixed:

| | |
|---|---|
| Compound (B-8) | 1.015 g |
| Compound (D-16) | 3.985 g |
| 0.25% Pt catalyst | 2.00 g |
| Ethylene carbonate | 11.93 g |
| Diethyl carbonate | 24.23 g |
| LiPF₆ | 6.8 g |

A 30 μm thick non-woven fabric was impregnated with the mixture at a weight per unit area of 15 g/m², and heated for 1 hour at 50° C. to obtain a gelled ionic conductive composition 2 with a thickness of 32 μm. The ionic conductivity of the gelled ionic conductive composition 2 was 1.0×10⁻³ S/cm.

### Example 3

The following materials were mixed, and the mixture was heated for 2 hours at 50° C. to obtain a catalyst 1 with a Pt concentration of 0.18%:

| | |
|---|---|
| Compound (D-16) | 10.0 g |
| 12.0% Pt catalyst | 0.15 g |

Then, the catalyst 1 was promptly mixed at room temperature in the following manner:

| | |
|---|---|
| Compound (B-1) | 0.259 g |
| Catalyst 1 | 2.782 g |
| LiPF₆ | 7.1 g |
| Ethylene carbonate | 13.14 g |
| Diethyl carbonate | 26.68 g |

The mixture was placed in a 2 mm thick closed vessel, and gelled at room temperature to obtain a gelled ionic conductive composition 3. The ionic conductivity of the gelled ionic conductive composition 3 was 1.5×10⁻³ S/cm.

To evaluate the performance of the gelled ionic conductive composition 3 as an electrolytic solution for a lithium secondary battery, a positive electrode layer and a negative electrode layer were withdrawn from a commercially available lithium secondary battery, whereafter metallic aluminum, the withdrawn positive electrode layer, the gelled ionic conductive composition 3, the withdrawn negative electrode layer, and metallic copper were laminated to prepare a lithium secondary battery. This battery was charged and discharged at an electric current value of 0.1 mA, and found to have capacity of 1.7 mAh/cm².

### Example 4

The following materials were mixed:

| | |
|---|---|
| Compound (A-3) | 1.766 g |
| Compound (F-1) | 0.034 g |
| 0.25% Pt catalyst | 0.80 g |
| Ethylene carbonate | 4.82 g |
| Diethyl carbonate | 9.78 g |
| LiPF₆ | 2.8 g |

The mixture was gelled in a 2 mm thick closed vessel to obtain a gelled ionic conductive composition 4. The ionic conductivity of the gelled ionic conductive composition 4 was 2.6×10⁻³ S/cm.

### Example 5

The following materials were mixed, and reacted at 80° C. in a nitrogen atmosphere, whereafter toluene was removed to synthesize a linear block copolymer (C-1) having hydrosilyl groups at both ends.

| | |
|---|---|
| Compound (A-1) | 793.4 g |
| Compound (B-1) | 206.6 g |
| Toluene | 1000 g |
| 0.25% Pt catalyst | 24.0 g |

Then, the block polymer (C-1) was mixed in the following manner:

| | |
|---|---|
| Block polymer (C-1) | 1.510 g |
| Compound (D-3) | 0.090 g |
| 0.25% Pt catalyst | 0.80 g |
| Ethylene carbonate | 4.89 g |
| Diethyl carbonate | 9.92 g |
| LiPF₆ | 2.80 g |

The mixture was placed in a 2 mm thick closed vessel, and heated for 1 hour at 50° C. to obtain a gelled ionic conductive composition 5. The ionic conductivity of the gelled ionic conductive composition 5 was 2.0×10⁻³ S/cm.

### Example 6

The block copolymer (C-1) prepared in Example 5 was mixed in the following manner:

| | |
|---|---|
| Block polymer (C-1) | 0.738 g |
| Compound (D-16) | 0.462 g |
| 0.25% Pt catalyst | 0.80 g |
| Ethylene carbonate | 3.00 g |
| Diethyl carbonate | 3.15 g |

The mixture was placed in a 2 mm thick closed vessel, and heated for 1 hour at 50° C. to obtain a gelled composition 1.

| | |
|---|---|
| LiPF₆ | 2.86 g |
| Ethylene carbonate | 2.00 g |
| Diethyl carbonate | 7.15 g |

Further, the gelled composition 1 was swollen with a solution containing the above compounds. The swollen composition was spread on a flat surface to obtain a gelled ionic conductive composition 6. The ionic conductivity of the gelled ionic conductive composition 6 was 3.0×10⁻³ S/cm.

The gelled ionic conductive composition 6 was coated onto metallic lithium to a film thickness of 25 microns, followed by gelation, and then combined with a positive electrode comprising lithium cobaltate to prepare a sheet-shaped battery. This battery was charged and discharged at an electric current value of 0.4 mA, and found to have capacity of 1.7 mAh/cm². Thus, this battery acted as a secondary battery.

### Example 7

The following materials were mixed, and reacted at 80° C. in a nitrogen atmosphere, whereafter toluene was removed to synthesize a linear block copolymer (C-2) having hydrosilyl groups at both ends.

| | |
|---|---|
| Compound (A-2) | 833.1 g |
| Compound (B-1) | 166.9 g |
| Toluene | 1000 g |
| 0.25% Pt catalyst | 24.0 g |

Separately, the following materials were mixed, and heated for 2 hours at 50° C. to obtain a catalyst 2 with a Pt concentration of 0.38%.

| | |
|---|---|
| Compound (D-16) | 15.5 g |
| 12.0% Pt catalyst | 0.50 g |

Then, the catalyst 2 was promptly mixed at room temperature in the following manner:

| | |
|---|---|
| Block polymer (C-2) | 0.786 g |
| Catalyst 2 | 0.427 g |
| Ethylene carbonate | 5.26 g |
| Diethyl carbonate | 10.67 g |
| LiPF₆ | 2.85 g |

The mixture was placed in a 2 mm thick closed vessel, and gelled at room temperature to obtain a gelled ionic conductive composition 7. The ionic conductivity of the gelled ionic conductive composition 7 was 5.5×10⁻³ S/cm.

To evaluate the performance of the gelled ionic conductive composition 7 as an electrolytic solution for a lithium secondary battery, a positive electrode layer and a negative electrode layer were withdrawn from a commercially available lithium secondary battery, whereafter metallic aluminum, the withdrawn positive electrode layer, the gelled ionic conductive composition 7, the withdrawn negative electrode layer, and metallic copper were laminated to prepare a lithium secondary battery. This battery was charged and discharged at an electric current value of 0.2 mA, and found to have capacity of 1.5 mAh/cm².

### Example 8

The following materials were mixed, and reacted at 80° C. in a nitrogen atmosphere, whereafter toluene was removed to synthesize a linear block copolymer (C-3) having hydrosilyl groups at both ends.

| | |
|---|---|
| Compound (A-5) | 572.3 g |
| Compound (B-1) | 427.7 g |
| Toluene | 1000 g |
| 0.25% Pt catalyst | 24.0 g |

Then, the block polymer (C-3) was mixed in the following manner:

| | |
|---|---|
| Block polymer (C-3) | 1.709 g |
| Compound (D-16) | 0.291 g |
| 0.25% Pt catalyst | 0.80 g |
| Ethylene carbonate | 6.99 g |
| Propylene carbonate | 6.99 g |
| LiN(CF₃SO₂)₂ | 3.22 g |

The mixture was placed in a 2 mm thick closed vessel, and heated for 1 hour at 50° C. to obtain a gelled ionic conductive composition 8. The ionic conductivity of the gelled ionic conductive composition 8 was 1.0×10⁻³ S/cm.

### Example 9

The following materials were mixed, and reacted at 80° C. in a nitrogen atmosphere, whereafter toluene was removed to synthesize a linear block copolymer (C-4) having hydrosilyl groups at both ends.

| | |
|---|---|
| Compound (A-2) | 888.7 g |
| Compound (B-1) | 111.3 g |
| Toluene | 1000 g |
| 0.25% Pt catalyst | 24.0 g |

Then, the block polymer (C-4) was mixed in the following manner:

| | |
|---|---|
| Block polymer (C-4) | 1.583 g |
| Compound (F-1) | 0.017 g |
| 0.25% Pt catalyst | 0.80 g |
| Ethylene carbonate | 4.89 g |
| Diethyl carbonate | 9.92 g |
| LiPF₆ | 2.80 g |

The mixture was placed in a 2 mm thick closed vessel, and heated for 1 hour at 50° C. to obtain a gelled ionic conductive composition 9. The ionic conductivity of the gelled ionic conductive composition 9 was 4.5×10⁻³ S/cm.

To evaluate the performance of the gelled ionic conductive composition 9 as an electrolytic solution for a lithium secondary battery, a positive electrode layer and a negative electrode layer were withdrawn from a commercially available lithium secondary battery, whereafter metallic aluminum, the withdrawn positive electrode layer, the gelled ionic conductive composition 9, the withdrawn negative electrode layer, and metallic copper were laminated to prepare a lithium secondary battery. This battery was charged and discharged at an electric current value of 0.1 mA, and found to have capacity of 1.6 mAh/cm².

### Example 10

The following materials were mixed:

| | |
|---|---|
| Compound (A-1) | 0.305 g |
| Compound (B-1) | 1.172 g |
| Compound (D-16) | 0.923 g |
| 0.25% Pt catalyst | 0.80 g |
| Ethylene carbonate | 4.50 g |
| Diethyl carbonate | 9.14 g |
| LiN(CF₃SO₂)₂ | 3.15 g |

The mixture was placed in a 2 mm thick closed vessel, and heated for 1 hour at 50° C. for gelation, thereby obtaining a gelled ionic conductive composition 10. The ionic conductivity of the gelled ionic conductive composition 10 was 0.8×10⁻³ S/cm.

### Example 11

The following materials were mixed:

| | |
|---|---|
| Compound (a-1) | 0.221 g |
| Compound (F-1) | 0.034 g |
| Compound (D-16) | 3.345 g |
| 0.25% Pt catalyst | 1.20 g |
| Ethylene carbonate | 7.05 g |
| Diethyl carbonate | 14.32 g |
| LiPF₆ | 3.83 g |

The mixture was placed in a 2 mm thick closed vessel, and heated for 1 hour at 50° C. for gelation, thereby obtaining a gelled ionic conductive composition 11. The ionic conductivity of the gelled ionic conductive composition 11 was 1.0×10⁻³ S/cm. Then, a 30 Am thick non-woven fabric was sandwiched between a negative electrode comprising lithium cobaltate and a positive electrode comprising carbon at a weight per unit area of 15 g/m². The composite was placed under reduced pressure, and the gelled ionic conductive composition 11 was used in place of an electrolytic solution to prepare a lithium secondary battery. This battery was charged and discharged at an electric current value of 0.4 mA, and found to have capacity of 1.4 mAh/cm². Thus, this battery acted as a secondary battery.

### Example 12

The following materials were mixed, and heated for 30 minutes at 50° C. to obtain a gelled composition 2.

| | |
|---|---|
| Compound (a-2) | 0.117 g |
| Compound (F-1) | 0.053 g |
| Compound (D-16) | 2.230 g |
| 0.25% Pt catalyst | 0.96 g |
| Ethylene carbonate | 4.46 g |
| Diethyl carbonate | 5.14 g |

Then, the gelled composition 2 was swollen with a solution containing the following compounds, thereby obtaining a gelled ionic conductive composition 12.

| | |
|---|---|
| LiPF₆ | 4.05 g |
| Ethylene carbonate | 3.00 g |
| Diethyl carbonate | 10.00 g |

The ionic conductivity of the gelled ionic conductive composition 12 was 1.5×10⁻³ S/cm. Then, a 30 μm thick non-woven fabric at a weight per unit area of 15 g/m² was sandwiched between a negative electrode comprising lithium cobaltate and a positive electrode comprising carbon. The composite was placed under reduced pressure, and the gelled ionic conductive composition 12 was used in place of an electrolytic solution to prepare a lithium secondary battery. This battery was charged and discharged at an electric current value of 0.4 mA, and found to have capacity of 1.5 mAh/cm². Thus, this battery acted as a secondary battery.

### Example 13

The following materials were mixed, and reacted at 80° C. in a nitrogen atmosphere, whereafter toluene was removed to synthesize a polyether-modified compound (L-1) having Si—H groups.

| | |
|---|---|
| Compound (a-1) | 865.4 g |
| Compound (F-1) | 134.6 g |
| Toluene | 500.0 g |
| 0.25% Pt catalyst | 18.0 g |

Then, the synthesized polyether-modified compound (L-1) was mixed in the following manner, and the mixture was heated to obtain a gelled composition 3.

| | |
|---|---|
| Compound (L-1) | 1.303 g |
| Compound (D-16) | 2.297 g |
| 0.25% Pt catalyst | 0.36 g |
| Ethylene carbonate | 5.29 g |
| Diethyl carbonate | 5.80 g |

Then, he gelled composition 3 was swollen with a solution containing the following compounds, thereby obtaining a gelled ionic conductive composition 13.

| | |
|---|---|
| LiPF₆ | 3.96 g |
| Ethylene carbonate | 2.00 g |
| Diethyl carbonate | 9.00 g |

The ionic conductivity of the gelled ionic conductive composition 13 was 1.0×10⁻³ S/cm.

### Example 14

The following materials were mixed, and reacted at 80° C. in a nitrogen atmosphere, whereafter toluene was removed to synthesize a polyether-modified compound (L-2) having Si—H groups.

| | |
|---|---|
| Compound (a-2) | 687.5 g |
| Compound (F-1) | 312.5 g |
| Toluene | 500.0 g |
| 0.25% Pt catalyst | 18.0 g |

Then, the synthesized polyether-modified compound (L-2) was mixed in the following manner, and the mixture was heated to obtain a gelled ionic conductive composition 14.

| | |
|---|---|
| Compound (L-2) | 0.471 g |
| Compound (D-16) | 1.929 g |
| 0.25% Pt catalyst | 1.80 g |
| Ethylene carbonate | 6.99 g |
| Diethyl carbonate | 14.19 g |
| LiN(CF₃SO₂)₂ | 4.62 g |

The ionic conductivity of the gelled ionic conductive composition 14 was 5.0×10⁻³ S/cm.

To evaluate the performance of the gelled ionic conductive composition 14 as an electrolytic solution for a lithium secondary battery, a positive electrode layer and a negative electrode layer were withdrawn from a commercially available lithium secondary battery, whereafter metallic aluminum, the withdrawn positive electrode layer, the gelled ionic conductive composition 14, the withdrawn negative electrode layer, and metallic copper were laminated to prepare a lithium secondary battery. This battery was charged and discharged at an electric current value of 0.1 mA, and found to have capacity of 1.6 mAh/cm².

### Example 15

A gelled ionic conductive composition 15 was obtained in the same manner as in Example 3. The ionic conductivity of the gelled ionic conductive composition 15 was 1.2×10⁻³ S/cm.

To evaluate the performance of the gelled ionic conductive composition 15 as an electrolyte layer for an electric double layer capacitor, 80 g of highly activated carbon having a specific surface area of 2000 m²/g and an average particle size of 8 μm, 10 g of acetylene black, 100 g of PVDF with a concentration of 12% (N-methylpyrrolidone solution), and 150 g of N-methylpyrrolidone were mixed to prepare an activated carbon-containing liquid. This liquid was coated onto an aluminum foil to prepare an electrode for a capacitor. The gelled ionic conductive composition 15 was laminated so as to be sandwiched between two of the electrodes to prepare an electric double layer capacitor. The capacity of this electric double layer capacitor was 0.2 F, and 10 F per gram of activated carbon.

### Example 16

The gelled composition 1 of Example 6 was swollen with a solution containing the following compounds. The swollen composition was spread on a flat surface to obtain a gelled ionic conductive composition 16.

| | |
|---|---|
| (C₂H₅)₄NBF₄ | 2.14 g |
| Propylene carbonate | 9.87 g |

The ionic conductivity of the gelled ionic conductive composition 16 was 1.2×10⁻³ S/cm. The gelled ionic conductive composition 16, and the electrodes of Example 15 were laminated in the manner described in Example 15 to prepare an electric double layer capacitor. The capacity of this electric double layer capacitor was 0.1 F, and 9 F per gram of activated carbon.

### Example 17

The linear block copolymer (C-2) and catalyst 2 of Example 7 were promptly mixed at room temperature in the following manner:

| | |
|---|---|
| Block polymer (C-2) | 0.786 g |
| Catalyst 2 | 0.427 g |
| (C₂H₅)₄NBF₄ | 3.34 g |
| Propylene carbonate | 15.44 g |

The mixture was placed in a 2 mm thick closed vessel, and gelled at room temperature to obtain a gelled ionic conductive composition 17. The ionic conductivity of the gelled ionic conductive composition 17 was 3.9×10⁻³ S/cm. The gelled ionic conductive composition 17, and the electrodes of Example 15 were laminated in the manner described in Example 15 to prepare an electric double layer capacitor. The capacity of this electric double layer capacitor was 0.1 F, and 11 F per gram of activated carbon.

### Example 18

The linear block copolymer (C-4) of Example 9 was mixed in the following manner:

| | |
|---|---|
| Block polymer (C-4) | 1.583 g |
| Compound (F-1) | 0.017 g |
| 0.25% Pt catalyst | 0.80 g |
| (C₂H₅)₄NBF₄ | 3.13 g |
| Propylene carbonate | 14.48 g |

The mixture was placed in a 2 mm thick closed vessel, and heated for 1 hour at 50° C. to obtain a gelled ionic conductive composition 18. The ionic conductivity of the gelled ionic conductive composition 18 was 2.5×10⁻³ S/cm. The gelled ionic conductive composition 18, and the electrodes of Example 15 were laminated in the manner described in Example 15 to prepare an electric double layer capacitor. The capacity of this electric double layer capacitor was 0.2 F, and 9 F per gram of activated carbon.

### Example 19

The following materials were mixed:

| | |
|---|---|
| Compound (a-1) | 0.221 g |
| Compound (F-1) | 0.034 g |
| Compound (D-16) | 3.345 g |
| 0.25% Pt catalyst | 1.20 g |
| (C₂H₅)₄NBF₄ | 4.49 g |
| Propylene carbonate | 20.71 g |

The mixture was placed in a 2 mm thick closed vessel, and heated for 1 hour at 50° C. for gelation, thereby obtaining a gelled ionic conductive composition 19. The ionic conductivity of the gelled ionic conductive composition 19 was 1.0×10⁻³ S/cm.

Then, a 30 μm thick non-woven fabric at a weight per unit area of 15 g/m² was sandwiched between two of the electrodes of Example 15. The composite was placed under reduced pressure, and the gelled ionic conductive composition 19 was used as an electrolyte layer to prepare an electric double layer capacitor. The capacity of this electric double layer capacitor was 0.1 F, and 9 F per gram of activated carbon.

### Example 20

The following materials were mixed, and heated for 30 minutes at 50° C. to obtain a gelled composition 4.

| | |
|---|---|
| Compound (a-2) | 0.117 g |
| Compound (F-1) | 0.053 g |
| Compound (D-16) | 2.230 g |
| 0.25% Pt catalyst | 0.96 g |
| Propylene carbonate | 9.60 g |

Then, the gelled composition 4 was swollen with a solution containing the following compounds, thereby obtaining a gelled ionic conductive composition 20.

| | |
|---|---|
| (C₂H₅)₄NBF₄ | 3.03 g |
| Propylene carbonate | 14.02 g |

The ionic conductivity of the gelled ionic conductive composition 20 was 0. 9×10⁻³ S/cm. Then, a 30 μm thick non-woven fabric at a weight per unit area of 15 g/m² was sandwiched between two of the electrodes of Example 15. The composite was placed under reduced pressure, and the gelled ionic conductive composition 20 was used as an electrolyte layer to prepare an electric double layer capacitor. The capacity of this electric double layer capacitor was 0.2 F, and 10 F per gram of activated carbon.

### Example 21

The polyether-modified compound (L-2) of Example 14 was mixed in the following manner, and the mixture was heated to obtain a gelled ionic conductive composition 21.

| | |
|---|---|
| Compound (L-2) | 0.471 g |
| Compound (D-16) | 1.929 g |
| 0.25% Pt catalyst | 1.80 g |
| (C₂H₅)₄NBF₄ | 4.59 g |
| Propylene carbonate | 21.21 g |

The ionic conductivity of the gelled ionic conductive composition 21 was 3.2×10⁻³ S/cm. Then, a 30 μm thick non-woven fabric at a weight per unit area of 15 g/m² was sandwiched between two of the electrodes of Example 15. The composite was placed under reduced pressure, and the gelled ionic conductive composition 21 was used as an electrolyte layer to prepare an electric double layer capacitor. The capacity of this electric double layer capacitor was 0.1 F, and 10 F per gram of activated carbon.

### Example 22

The following materials were mixed, and reacted at 80° C. in a nitrogen atmosphere, whereafter toluene was removed to synthesize a linear block copolymer (C-5) having hydrosilyl groups at both ends.

| | |
|---|---|
| Compound (A-2) | 803.8 g |
| Compound (B-3) | 196.2 g |
| 0.25% Pt catalyst | 25.0 g |
| Toluene | 1000 g |

The block copolymer (C-5) was mixed in the following manner to obtain a non-gelled ionic conductive composition 22.

| | | |
|---|---|---|
| Block copolymer (C-5) | 6.963 | g |
| Compound (D-3) | 0.217 | g |
| 0.25% Pt catalyst | 4.50 | g |
| LiPF₆ | 15.2 | g |
| Dimethyl maleate | 1.25 | mg |
| Propylene carbonate | 95.00 | g |

The viscosity of the ionic conductive composition 22 was measured with E Type Viscometer VISCONIC ELD (produced by Tokyo Keiki) immediately after preparation and 6 hours after preparation. The viscosities at 25° C. were 6.5 mPa·s and 15.3 mPa·s, respectively. Thus, the increase of viscosity during this period was 135%.

To evaluate the performance of the ionic conductive composition 22 as an electrolytic solution for a lithium secondary battery, a positive electrode layer, a negative electrode layer, and a separator were withdrawn from a commercially available lithium secondary battery (nominal capacity 500 mAh). The separator was washed with diethyl carbonate, and then dried. Then, metallic aluminum, the withdrawn positive electrode layer, separator, and negative electrode layer, and metallic copper were laminated, and the laminate was assembled into a cell can for a battery. The ionic conductive composition 22, 6 hours after preparation, was poured into the cell can. After the cell can was sealed, the system was heated for 7 hours at 60° C. to proceed with polymerization. The resulting lithium secondary battery was charged and discharged at 100 mA, and found to have capacity of 410 mAh.

On the other hand, an ionic conductive composition, which was obtained in the same manner as for the ionic conductive composition 22 except that dimethyl maleate had not been added, had viscosities at 25° C., immediately after preparation and 6 hours after preparation, of 6.5 mPa·s and 450 mPa·s, respectively. The increase of viscosity during this period was 6,820%. The capacity of a lithium secondary battery, obtained by pouring this ionic conductive composition aged for 6 hours after preparation, was 200 mAh. Decomposition of the lithium secondary battery after evaluation confirmed that the ionic conductive composition had not extended uniformly inside the cell can.

### Example 23

The following materials were mixed, and reacted at 80° C. in a nitrogen atmosphere, whereafter toluene was removed to synthesize a linear block copolymer (C-6) having hydrosilyl groups at both ends.

| | |
|---|---|
| Compound (A-1) | 443.2 g |
| Compound (B-7) | 556.8 g |
| 0.25% Pt catalyst | 24.0 g |
| Toluene | 1000 g |

Then, the block copolymer (C-6) was mixed in the following manner to obtain a non-gelled ionic conductive composition 23.

| | | |
|---|---|---|
| Block copolymer (C-6) | 9.516 | g |
| Compound (D-21) | 2.484 | g |
| 0.25% Pt catalyst | 5.00 | g |
| (C₂H₅)₄NBF₄ | 21.06 | g |
| Dibenzyl maleate | 3.50 | mg |
| Propylene carbonate | 90.00 | g |

The viscosity of the ionic conductive composition 23 was measured in the same manner as in Example 22 immediately after preparation and 6 hours after preparation. The viscosities at 25° C. were 9.7 mPa·s and 11.3 mPa·s, respectively. Thus, the increase of viscosity during this period was 16.5%.

To evaluate the performance of the ionic conductive composition 23 as an electrolyte layer for an electric double layer capacitor, 80 g of finely divided activated carbon having a specific surface area of 2000 m²/g and an average particle size of 8 μm, and 20 g of tetrafluoroethylene powder were kneaded, and then coated in a hot state onto an aluminum foil to prepare an electrode for a capacitor. This electrode for a capacitor, and a commercially available cellulose separator were assembled into a cell for a capacitor. Then, the ionic conductive composition 23, aged for 6 hours after preparation, was poured into the cell, whereafter the cell was sealed. This cell was heated for 7 hours at 50° C. to proceed with polymerization, thereby obtaining an electric double layer capacitor. The capacity of this electric double layer capacitor was 30 F.

On the other hand, an ionic conductive composition, which was obtained in the same manner as for the ionic conductive composition 23 except that dibenzyl maleate had not been added, had viscosities at 25° C., immediately after preparation and 15 minutes after preparation, of 9.7 mPa·s and 280 mPa·s, respectively. In 20 minutes, this ionic conductive composition lost fluidity. The capacity of an electric double layer capacitor, obtained by pouring this ionic conductive composition aged for 15 minutes after preparation, was 13 mAh. Decomposition of the electric double layer capacitor after evaluation confirmed that the ionic conductive composition had not extended uniformly inside the cell can. Furthermore, the weight of the electric double layer capacitor revealed that the necessary amount of the ionic conductive composition had not been poured, because the viscosity of the ionic conductive composition was high.

### Example 24

The gelled composition 1 of Example 6 was swollen with a solution containing the following compounds. The swollen composition was spread on a flat surface to obtain a gelled ionic conductive composition 24.

| | |
|---|---|
| (C₂H₅)₄NBF₄ | 1.34 g |
| Acetonitrile | 10.66 g |

The ionic conductivity of the gelled ionic conductive composition 24 was 1.5×10⁻² S/cm.

To evaluate the performance of the gelled ionic conductive composition 24 as an electrolyte layer for an electric double layer capacitor, 80 g of finely divided activated carbon having a specific surface area of 2000 m²/g and an average particle size of 8 μm, and 20 g of tetrafluoroethylene powder were kneaded, and then coated in a hot state onto an aluminum foil to prepare an electrode for a capacitor. The gelled ionic conductive composition 24 was laminated so as to be sandwiched between two of the electrodes for capacitor to obtain an electric double layer capacitor. The capacity of this electric double layer capacitor was 0.25 F, and 10 F per gram of activated carbon.

### Example 25

The linear block copolymer (C-2) and catalyst 2 of Example 7 were promptly mixed at room temperature in the following manner:

| | |
|---|---|
| Block polymer (C-2) | 0.786 g |
| Catalyst 2 | 0.427 g |
| (C₂H₅)₄NBF₄ | 2.10 g |
| Acetonitrile | 16.68 g |

The mixture was placed in a 2 mm thick closed vessel, and gelled at room temperature to obtain a gelled ionic conductive composition 25. The ionic conductivity of the gelled ionic conductive composition 25 was 2.2×10⁻² S/cm. The gelled ionic conductive composition 25, and the electrodes of Example 24 were laminated in the manner described in Example 24 to prepare an electric double layer capacitor. The capacity of this electric double layer capacitor was 0.15 F, and 6 F per gram of activated carbon.

### Example 26

The linear block copolymer (C-4) of Example 9 was mixed in the following manner:

| | |
|---|---|
| Block polymer (C-4) | 1.586 g |
| Compound (F-1) | 0.014 g |
| 0.25% Pt catalyst | 0.80 g |
| (C₂H₅)₄NBF₄ | 3.13 g |
| γ-butyrolactone | 12.21 g |

The mixture was placed in a 2 mm thick closed vessel, and heated for 1 hour at 50° C. to obtain a gelled ionic conductive composition 26. The ionic conductivity of the gelled ionic conductive composition 26 was 2.2×10⁻³ S/cm. The gelled ionic conductive composition 26, and the electrodes of Example 24 were laminated in the manner described in Example 24 to prepare an electric double layer capacitor. The capacity of this electric double layer capacitor was 0.18 F, and 10 F per gram of activated carbon.

### Example 27

The following materials were mixed:

| | |
|---|---|
| Compound (a-1) | 1.128 g |
| Compound (F-1) | 0.175 g |
| Compound (D-16) | 2.297 g |
| 0.25% Pt catalyst | 1.20 g |
| (C₂H₅)₄NBF₄ | 4.49 g |
| γ-butyrolactone | 17.46 g |

The mixture was placed in a 2 mm thick closed vessel, and heated for 1 hour at 50° C. for gelation, thereby obtaining a gelled ionic conductive composition 27. The ionic conductivity of the gelled ionic conductive composition 27 was 9.8×10⁻² S/cm.

Then, a 30 μm thick non-woven fabric at a weight per unit area of 15 g/m² was sandwiched between two of the electrodes of Example 24. The composite was placed under reduced pressure, and the gelled ionic conductive composition 27 was used as an electrolyte layer to prepare an electric double layer capacitor. The capacity of this electric double layer capacitor was 0.09 F, and 7 F per gram of activated carbon.

### Example 28

The gelled composition 4 of Example 20 was swollen with a solution containing the following compounds, thereby obtaining a gelled ionic conductive composition 28.

| | | |
|---|---|---|
| 1-Methyl-4-ethylimidazolium | 1.84 | g |
| tetrafluoroborate | | |
| Propylene carbonate | 15.21 | g |

The ionic conductivity of the gelled ionic conductive composition 28 was 1.1×10⁻³ S/cm. Then, a 30 μm thick non-woven fabric at a weight per unit area of 15 g/m² was sandwiched between two of the electrodes of Example 24. The composite was placed under reduced pressure, and the gelled ionic conductive composition 28 was used as an electrolyte layer to prepare an electric double layer capacitor. The capacity of this electric double layer capacitor was 0.18 F, and 9 F per gram of activated carbon.

### Example 29

The polyether-modified compound (L-2) of Example 14 was mixed in the following manner, and the mixture was heated to obtain a gelled ionic conductive composition 29.

| | | |
|---|---|---|
| Compound (L-2) | 0.471 | g |
| Compound (D-16) | 1.929 | g |
| 0.25% Pt catalyst | 1.80 | g |
| (C₂H₅)₄NBF₄ | 2.89 | g |
| Acetonitrile | 22.92 | g |

The ionic conductivity of the gelled ionic conductive composition 29 was 8.2×10⁻² S/cm. Then, a 30 μm thick non-woven fabric at a weight per unit area of 15 g/m² was sandwiched between two of the electrodes of Example 24. The composite was placed under reduced pressure, and the gelled ionic conductive composition 29 was used as an electrolyte layer to prepare an electric double layer capacitor. The capacity of this electric double layer capacitor was 0.1 F, and 9 F per gram of activated carbon.

### Example 30

The linear block copolymer (C-4) of Example 9 was mixed in the following manner:

| | | |
|---|---|---|
| Block polymer (C-4) | 1.583 | g |
| Compound (F-1) | 0.017 | g |
| 0.25% Pt catalyst | 0.80 | g |
| Tetramethylammonium | 4.07 | g |
| phthalate | | |
| γ-Butyrolactone | 12.21 | g |

The mixture was placed in a 2 mm thick closed vessel, and heated for 1 hour at 50° C. to obtain a gelled ionic conductive composition 30. The ionic conductivity of the gelled ionic conductive composition 30 was 4.1×10⁻³ S/cm.

To evaluate the performance of the gelled ionic conductive composition 30 as an electrolyte layer for an electrolytic capacitor, a connector for an anode was spot welded to one surface of an electrode made of an aluminum foil having a thickness of 0.05 mm and an etching hole diameter of 1 to 5 μm. Then, the welded electrode was immersed in an aqueous solution of boric acid (concentration 80 g/l) maintained at a temperature of 90° C., and the aluminum foil surface was oxidized for 15 minutes at an electric current of 30 A to form an aluminum oxide dielectric layer, thereby preparing an anode for an electrolytic capacitor. Separately, a connector for a cathode was spot welded to one surface of an electrode made of an aluminum foil having a thickness of 0.05 mm and an etching hole diameter of 1 to 5 μm, thus preparing a cathode for an electrolytic capacitor.

Then, the gelled ionic conductive composition 30 was coated onto the dielectric layer of the anode to a film thickness of 30 μm. The coated anode was combined with the cathode, wound up, and then allowed to stand in a cell for 3 hours at 50° C. to produce a sheet-shaped aluminum electrolytic capacitor. The electrostatic capacity of the aluminum electrolytic capacitor was 220 μF.

### Example 31

The block copolymer (C-1) described in Example 5 was mixed in the following manner:

| | | |
|---|---|---|
| Block polymer (C-1) | 0.738 | g |
| Compound (D-16) | 0.462 | g |
| 0.25% Pt catalyst | 0.80 | g |
| γ-Butyrolactone | 6.15 | g |

The mixture was placed in a 2 mm thick closed vessel, and heated for 1 hour at 50° C. to obtain a gelled composition 5.

| | |
|---|---|
| Tetramethylammonium | 3.04 g |
| phthalate | |
| γ-Butyrolactone | 9.16 g |

Further, the gelled composition 5 was swollen with a solution containing the above compounds. The swollen composition was spread on a flat surface to obtain a gelled ionic conductive composition 31. The ionic conductivity of the gelled ionic conductive composition 31 was 1.5×10⁻³ S/cm.

The gelled ionic conductive composition 31 was coated onto a dielectric layer of an anode to a film thickness of 30 μm in the same manner as in Example 30. The coated anode was combined with the cathode, and the combination was wound up, and then allowed to stand in a cell for 3 hours at 50° C. to produce a sheet-shaped aluminum electrolytic capacitor. The electrostatic capacity of the aluminum electrolytic capacitor was 280 μF.

### Example 32

The following materials were mixed:

| | | |
|---|---|---|
| Compound (A-1) | 1.172 | g |
| Compound (B-1) | 0.305 | g |
| Compound (D-16) | 0.923 | g |
| 0.25% Pt catalyst | 0.80 | g |
| Ethylene carbonate | 4.50 | g |
| Diethyl carbonate | 9.14 | g |
| LiN(CF₃SO₂)₂ | 6.15 | g |

The mixture was placed in a 2 mm thick closed vessel, and heated for 1 hour at 50° C. for gelation, thereby obtaining a gelled ionic conductive composition 32. The ionic conductivity of the gelled ionic conductive composition 32 was 0.8×10⁻³ S/cm.

### Example 33

The following materials were mixed:

| | | |
|---|---|---|
| Compound (a-1) | 1.128 | g |
| Compound (F-1) | 0.175 | g |
| Compound (D-16) | 2.297 | g |
| 0.25% Pt catalyst | 1.20 | g |
| Ethylene carbonate | 7.05 | g |
| Diethyl carbonate | 14.32 | g |
| LiPF₆ | 3.83 | g |

The mixture was placed in a 2 mm thick closed vessel, and heated for 1 hour at 50° C. for gelation, thereby obtaining a gelled ionic conductive composition 33. The ionic conductivity of the gelled ionic conductive composition 33 was 1.0×10⁻³ S/cm. Then, a 30 μm thick non-woven fabric at a weight per unit area of 15 g/m² was sandwiched between a negative electrode comprising lithium cobaltate and a positive electrode comprising carbon. The composite was placed under reduced pressure, and the gelled ionic conductive composition 33 was used as an electrolytic solution to prepare a lithium secondary battery. This battery was charged and discharged at an electric current value of 0.4 mA, and found to have capacity of 1.4 mAh/cm². Thus, this battery acted as a secondary battery.

### Example 34

The following materials were mixed, and heated for 30 minutes at 50° C. to obtain a gelled composition 6.

| | | |
|---|---|---|
| Compound (a-2) | 0.324 | g |
| Compound (F-1) | 0.147 | g |
| Compound (D-16) | 1.929 | g |
| 0.25% Pt catalyst | 0.96 | g |
| Ethylene carbonate | 4.46 | g |
| Diethyl carbonate | 5.14 | g |

Then, the gelled composition 6 was swollen with a solution containing the following compounds, thereby obtaining a gelled ionic conductive composition 34.

| | | |
|---|---|---|
| LiPF₆ | 4.05 | g |
| Ethylene carbonate | 3.00 | g |
| Diethyl carbonate | 10.00 | g |

The ionic conductivity of the gelled ionic conductive composition 34 was 1.5×10⁻³ S/cm. Then, a 30 Am thick non-woven fabric at a weight per unit area of 15 g/m² was sandwiched between a negative electrode comprising lithium cobaltate and a positive electrode comprising carbon. The composite was placed under reduced pressure, and the gelled ionic conductive composition 34 was used in place of an electrolytic solution to prepare a lithium secondary battery. This battery was charged and discharged at an electric current value of 0.4 mA, and found to have capacity of 1.5 mAh/cm². Thus, this battery acted as a secondary battery.

### Example 35

The following materials were mixed:

| | | |
|---|---|---|
| Compound (a-1) | 1.128 | g |
| Compound (F-1) | 0.175 | g |
| Compound (D-16) | 2.297 | g |
| 0.25% Pt catalyst | 1.20 | g |
| (C₂H₅)₄NBF₄ | 4.49 | g |
| Propylene carbonate | 20.71 | g |

The mixture was placed in a 2 mm thick closed vessel, and heated for 1 hour at 50° C. for gelation, thereby obtaining a gelled ionic conductive composition 35. The ionic conductivity of the gelled ionic conductive composition 35 was 1.0×10⁻³ S/cm.

Then, a 30 μm thick non-woven fabric at a weight per unit area of 15 g/m² was sandwiched between two of the electrodes of Example 15. The composite was placed under reduced pressure, and the gelled ionic conductive composition 35 was used as an electrolyte layer to prepare an electric double layer capacitor. The capacity of this electric double layer capacitor was 0.1 F, and 9 F per gram of activated carbon.

### Example 36

The following materials were mixed, and heated for 30 minutes at 50° C. to obtain a gelled composition 7.

| | |
|---|---|
| Compound (a-2) | 0.324 g |
| Compound (F-1) | 0.147 g |
| Compound (D-16) | 1.929 g |
| 0.25% Pt catalyst | 0.96 g |
| Propylene carbonate | 9.60 g |

Then, the gelled composition 7 was swollen with a solution containing the following compounds, thereby obtaining a gelled ionic conductive composition 36.

| | |
|---|---|
| (C₂H₅)₄NBF₄ | 3.03 g |
| Propylene carbonate | 14.02 g |

The ionic conductivity of the gelled ionic conductive composition 36 was 0.9×10⁻³ S/cm. Then, a 30 μm thick non-woven fabric at a weight per unit area of 15 g/m² was sandwiched between two of the electrodes of Example 15. The composite was placed under reduced pressure, and the gelled ionic conductive composition 36 was used as an electrolyte layer to prepare an electric double layer capacitor. The capacity of this electric double layer capacitor was 0.2 F, and 10 F per gram of activated carbon.

1. A gelled composition comprising a polymer and a solvent, said polymer being obtained by an addition reaction between a linear copolymer having two terminal hydrosilyl groups and a compound having 3 or more ethylenic double bonds, wherein
said linear copolymer being formed by copolymerizing a compound represented by the formula (A): 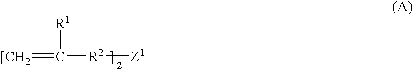
where
R¹ represents, independently of each other, a hydrogen atom, a substituted or unsubstituted alkyl group having 1 to 18 carbon atoms, or a substituted or unsubstituted aryl group having 6 to 20 carbon atoms;
R² represents, independently of each other, a substituted or unsubstituted alkylene group having 1 to 18 carbon atoms, a substituted or unsubstituted arylene group having 6 to 20 carbon atoms, a substituted or unsubstituted arylalkylene group having 7 to 21 carbon atoms, a dialkyl(poly)silylene group, a diaryl(poly)silylene group, or a bond; and
Z¹ represents a polyoxyalkylene group, a (poly)carbonate group, a (poly)ester group, an alkylene group having 1 to 36 carbon atoms, a hetero-atom-containing organic group having 1 to 6 hetero-atoms and 1 to 30 carbon atoms, a divalent group derived from polyacrylate or polymethacrylate, or a bond; and a compound represented by the formula (B): 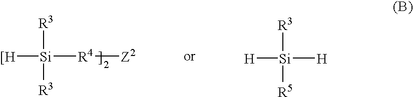
where
R³ represents, independently of each other, a substituted or unsubstituted alkyl group having 1 to 18 carbon atoms, a substituted or unsubstituted aralkyl group having 7 to 21 carbon atoms, or a substituted or unsubstituted aryl group having 6 to 20 carbon atoms;
R⁴ represents, independently of each other, a substituted or unsubstituted alkylene group having 1 to 18 carbon atoms, a substituted or unsubstituted arylene group having 6 to 20 carbon atoms, a substituted or unsubstituted arylalkylene group having 7 to 21 carbon atoms, a dialkyl(poly)silylene group, a diaryl(poly)silylene group, or a bond;
R⁵ represents a substituted or unsubstituted alkyl group having 2 to 18 carbon atoms, a substituted or unsubstituted aralkyl group having 7 to 21 carbon atoms, or a substituted or unsubstituted aryl group having 6 to 20 carbon atoms; and
Z² represents a divalent linking group which is a disubstituted divalent silicon atom, a substituted or unsubstituted alkylene group having 1 to 18 carbon atoms, a substituted or unsubstituted arylene group having 6 to 20 carbon atoms, a hetero-atom-containing organic group having 1 to 6 hetero-atoms and 1 to 30 carbon atoms, a benzenepolycarboxyl group, a phosphate group, a polyoxyalkylene group, a (poly)carbonate group, a (poly)ester group, a group derived from polyacrylate or polymethacrylate, or a bond;
said compound having 3 or more ethylenic double bonds being a compound represented by the formula (D): 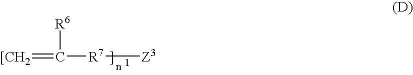
where
R⁶ represents, independently of each other, a hydrogen atom, a substituted or unsubstituted alkyl group having 1 to 18 carbon atoms, or a substituted or unsubstituted aryl group having 6 to 20 carbon atoms;
R⁷ represents, independently of each other, a substituted or unsubstituted alkylene group having 1 to 18 carbon atoms, a substituted or unsubstituted arylene group having 6 to 20 carbon atoms, a substituted or unsubstituted arylalkylene group having 7 to 21 carbon atoms, a hetero-atom-containing alkylene group having 1 to 6 hetero-atoms and 1 to 30 carbon atoms, or a bond;
n¹ denotes an integer of 3 or higher; and
Z³ represents a linking group having the same valence number as n¹ which is a carbon atom, an alkynyl group having 1 to 18 carbon atoms, an alkanepolyyl group having 1 to 12 carbon atoms, a silicon atom, a monosubstituted trivalent silicon atom, an aliphatic group having 1 to 300 carbon atoms, a hetero-atom-containing organic group having 1 to 50 hetero-atoms and 1 to 100 carbon atoms, a benzenepolycarboxyl group, a phosphate group, an oxyphosphate group, a group derived from (poly)carbonate, poly(ester), polyacrylate or polymethacrylate, or a bond; and
said addition reaction being carried out in the presence or absence of the compound represented by the formula (A) and/or the compound represented by the formula (B).

2. The composition according to claim 1, wherein said linear copolymer is reacted with the compound represented by the formula (D) in the absence of the compound represented by the formula (A) and the compound represented by the formula (B).

3. The composition according to claim 1, wherein said linear copolymer is reacted with the compound represented by the formula (D) in the presence of the compound represented by the formula (A) and in the absence of the compound represented by the formula (B).

4. The composition according to claim 1, wherein said linear copolymer is reacted with the compound represented by the formula (D) in the presence of the compound represented by the formula (B) and in the absence of the compound represented by the formula (A).

5. The composition according to claim 1, wherein said linear copolymer is reacted with the compound represented by the formula (D) in the presence of both of the compound represented by the formula (A) and the compound represented by the formula (B).

6. A gelled composition comprising a polymer and a solvent, said polymer being obtained by a simultaneous addition reaction of the compound represented by the formula (A) according to claim 1, the compound represented by the formula (B) according to claim 1, and the compound represented by the formula (D) according to claim 1.

7. A gelled composition comprising a polymer and a solvent, said polymer being obtained by an addition reaction of the compound represented by the formula (B) and the compound represented by the formula (D) according to claim 1.

8. A gelled composition comprising a polymer and a solvent, said polymer being obtained by an addition reaction between a linear copolymer having two terminal ethylenic double bonds and a compound having 3 or more hydrosilyl groups, wherein
said linear copolymer being formed by copolymerizing a compound represented by the formula (A) according to claim 1 and a compound represented by the formula (B) according to claim 1;
said compound having 3 or more hydrosilyl groups represented by the formula (F): 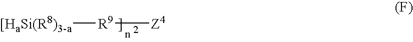
where
R⁸ represents, independently of each other, a substituted or unsubstituted alkyl group having 1 to 18 carbon atoms, or a substituted or unsubstituted aryl group having 6 to 20 carbon atoms;
R⁹ represents, independently of each other, a substituted or unsubstituted alkylene group having 1 to 18 carbon atoms, a substituted or unsubstituted arylene group having 6 to 20 carbon atoms, a substituted or unsubstituted arylalkylene group having 7 to 21 carbon atoms, a hetero-atom-containing alkylene group having 1 to 6 hetero-atoms and 1 to 30 carbon atoms, or a bond;
Z⁴ represents a linking group having the same valence number as n² which is a carbon atom, an alkynyl group having 1 to 18 carbon atoms, an alkanepolyyl group having 1 to 12 carbon atoms, a silicon atom, a monosubstituted trivalent silicon atom, an aliphatic group having 1 to 300 carbon atoms, a hetero-atom-containing organic group having 1 to 50 hetero-atoms and 1 to 100 carbon atoms, a benzenepolycarboxyl group, a phosphate group, an oxyphosphate group, a group derived from (poly)carbonate, poly(ester), polyacrylate or polymethacrylate, or a bond;
a represents, independently of each other, an integer of 1 to 3; and
n² denotes an integer of 1 to 30, provided that when n² is 1, R⁹ represents a bond and Z⁴ represents a hydrogen atom or has the same meaning as R⁸, and that in any case, at least 3 hydrogen atoms bonded to the Si atom are present in the molecule; and
said addition reaction being carried out in the presence or absence of the compound represented by the formula (A) and/or the compound represented by the formula (B).

9. The composition according to claim 8, wherein said linear copolymer is reacted with the compound represented by the formula (F) in the absence of the compound represented by the formula (A) and the compound represented by the formula (B).

10. The composition according to claim 8, wherein said linear copolymer is reacted with the compound represented by the formula (F) in the presence of the compound represented by the formula (A) and in the absence of the compound represented by the formula (B).

11. The composition according to claim 8, wherein said linear copolymer is reacted with the compound represented by the formula (F) in the presence of the compound represented by the formula (B) and in the absence of the compound represented by the formula (A).

12. The composition according to claim 8, wherein said linear copolymer is reacted with the compound represented by the formula (F) in the presence of both of the compound represented by the formula (A) and the compound represented by the formula (B).

13. A gelled composition comprising a polymer and a solvent, said polymer being obtained by an addition reaction of the compound represented by the formula (A) according to claim 1 and the compound represented by the formula (F) according to claim 8.

14. The composition according to any one of claims 1 to 13, wherein the solvent is present in said composition in a amount of 50 to 99% by weight.

15. A gelled ionic conductive composition comprising the composition according to any one of claims 1 to 14 and an electrolyte.

16. The composition according to claim 15, wherein the electrolyte is already present when the composition according to any one of claims 1 to 14 is produced.

17. The composition according to claim 15 or 16 having storage modulus of 3,000 pascals or higher.

18. The composition according to any one of claims 15 to 17, further containing a modified silicone having a viscosity of 10,000 cP or less at 40° C.

19. The composition according to any one of claims 15 to 18 whose ionic conductivity at −20° C. is not less than 50% of the ionic conductivity of an electrolytic solution consisting of the electrolyte and the solvent.

20. The composition according to any one of claims 15 to 19, further containing a thermoplastic resin in the form of particles, fibers or a porous film.

21. A battery comprising the gelled ionic conductive composition according to any one of claims 15 to 20.

22. An electrochemical device comprising the gelled ionic conductive composition according to any one of claims 15 to 20.

23. The electrochemical device according to claim 22, which is a solar cell, a capacitor, a sensor, or an electrochromic display device.

24. The electrochemical device according to claim 23, which is a capacitor containing the gelled ionic conductive composition as an electrolyte layer.

25. A method for producing a battery or an electrochemical device comprising a gelled ionic conductive composition, comprising:
preparing an enclosure of the battery or the electrochemical device;
preparing an ionic conductive composition comprising a linear copolymer having 2 terminal hydrosilyl groups obtained by an addition reaction between a compound represented by the formula (A) according to claim 1 and a compound represented by the formula (B) according to claim 1; a compound represented by the formula (b) according to claim 1; a solvent; and an electrolyte;
pouring the ionic conductive composition into the enclosure; and
polymerizing or crosslinking the ionic conductive composition in the enclosure to form the gelled ionic conductive composition.

26. A method for producing a battery or an electrochemical device comprising a gelled ionic conductive composition, comprising:
preparing an enclosure of the battery or the electrochemical device;
preparing an ionic conductive composition comprising a compound represented by the formula (B) according to claim 1, a compound represented by the formula (D) according to claim 1, a solvent, and an electrolyte;
pouring the ionic conductive composition into the enclosure; and
polymerizing or crosslinking the ionic conductive composition in the enclosure to form the gelled ionic conductive composition.

27. A method for producing a battery or an electrochemical device comprising a gelled ionic conductive composition, comprising:
preparing an enclosure of the battery or the electrochemical device;
preparing an ionic conductive composition comprising a linear copolymer having two terminal ethylenic double bonds obtained by an addition reaction between a compound represented by the formula (A) according to claim 1 and a compound represented by the formula (B) according to claim 1; a compound represented by the formula (F) according to claim 8; a solvent; and an electrolyte;
pouring the ionic conductive composition into the enclosure; and
polymerizing or crosslinking the ionic conductive composition in the enclosure to form the gelled ionic conductive composition.

28. A method for producing a battery or an electrochemical device comprising a gelled ionic conductive composition, comprising:
preparing an enclosure of the battery or the electrochemical device;
preparing an ionic conductive composition comprising a compound represented by the formula (A) according to claim 1, a compound represented by the formula (F) according to claim 8, a solvent, and an electrolyte;
pouring the ionic conductive composition into the enclosure; and
polymerizing or crosslinking the ionic conductive composition in the enclosure to form the gelled ionic conductive composition.

29. The method according to any one of claims 25 to 28, wherein a viscosity at 25° C. of the ionic conductive composition is 30 mPa·s or less immediately after preparation of the ionic conductive composition, and an increase of the viscosity after a lapse of 6 hours at 25° C. is within 300% compared with the viscosity immediately after the preparation.

30. The method according to claim 29, wherein the ionic conductive composition further comprises a polymerization inhibitor.
